(19) United States
(12) Patent Application Publication
(10) Pub. No.: US 2025/0326007 A1
(43) Pub. Date: Oct. 23, 2025

(54) WASHING DEVICE, IMPURITY REMOVAL SYSTEM AND WASHING METHOD

(71) Applicant: CONTEMPORARY AMPEREX TECHNOLOGY CO., LIMITED, Ningde (CN)

(72) Inventors: Kai WU, Ningde (CN); Bo ZHANG, Ningde (CN)

(21) Appl. No.: 19/254,506

(22) Filed: Jun. 30, 2025

Related U.S. Application Data
(63) Continuation of application No. PCT/CN2023/124082, filed on Oct. 11, 2023.

(30) Foreign Application Priority Data
Jun. 30, 2023 (CN) 202310789225.9

(51) Int. Cl. B08B 1/30; B08B 1/16

(52) U.S. Cl. CPC B08B 1/30; B08B 1/165

(57) ABSTRACT

A washing device, an impurity removal system and a washing method. The washing device is used for washing waste attached to an adsorption member. The washing device includes: a cleaning mechanism used for outputting a spacer; a scraping and washing mechanism which includes a clamping jaw and a first scraping and washing driving mechanism, wherein the clamping jaw is used for clamping the adsorption member by means of the spacer, and the first scraping and washing driving mechanism is used for driving the clamping jaw to open or clamp; and a first driving mechanism, which is used for driving the scraping and washing mechanism to move in an axial direction of the adsorption member, so as to scrape off the waste attached to the adsorption member.

### CROSS-REFERENCE TO RELATED APPLICATIONS

The present application is a continuation of International Application No. PCT/CN2023/124082, filed on Oct. 11, 2023, which claims the priority of the Chinese patent application with the application Number 202310789225.9 and filed by China Patent Office on Jun. 30, 2023, the entire contents of which are incorporated herein by reference.

### TECHNICAL FIELD

The present application relates to the field of iron removal for slurry fluid, and specifically relates to a washing device, an impurity removal system and a washing method.

### BACKGROUND

At present, in the production process of slurry, the slurry is easy to be polluted by impurities such as iron, and when the slurry is coated on a substrate in the future, the iron and other impurities in the slurry will scratch the substrate and affect the coating effect of the slurry. In order to reduce the impurities in the slurry, an iron remover may be used for iron removing and filtration. But the current iron remover works in a manual washing way, which is time-consuming and labor-intensive, and on the one hand, manual washing is easy to cause slurry splashing to pollute the environment; and on the other hand, due to the presence of corrosive substances in the slurry, manual washing has potential safety hazards. In addition, in the related technology, in the operating processing, the iron remover is easily polluted by the impurities to affect subsequent washing, resulting in the low washing efficiency of the iron remover.

### SUMMARY

In view of the above problems, the present application provides a washing device, an impurity removal system and a washing method to improve the washing efficiency and washing effect of washing an adsorption member.

In a first aspect, an embodiment of the present application provides a washing device used for washing waste attached to an adsorption member. The washing device includes a cleaning mechanism, a scraping and washing mechanism and a first driving mechanism. The cleaning mechanism is used for outputting a spacer; the scraping and washing mechanism includes a clamping jaw and a first scraping and washing driving mechanism, in which, the clamping jaw is used for clamping the adsorption member by means of the spacer, and the first scraping and washing driving mechanism is used for driving the clamping jaw to open or clamp; and the first driving mechanism is used for driving the scraping and washing mechanism to move in an axial direction of the adsorption member, so as to scrape off the waste attached to the adsorption member.

In the technical solution of this embodiment of the present application, the spacer is outputted by means of the cleaning mechanism, so that waste scraped off by the clamping jaw of the scraping and washing mechanism using the spacer cannot be attached to the clamping jaw of the scraping and washing mechanism, the influence of the waste polluting the scraping and washing mechanism on subsequent washing can be reduced, the cleaning on the scraping and washing mechanism is reduced, and accordingly the washing efficiency and washing effect of washing the adsorption member are improved.

In some embodiments, the spacer is a thin film, and the cleaning mechanism includes a supporting frame, a film clamping member, a film cutting member and a first film covering driving mechanism. The supporting frame is used for supporting a thin film roll; the film clamping member is used for clamping the thin film; the thin film cutting member is used for cutting off the thin film; and the first film covering driving mechanism is used for driving the thin film cutting member to move in a direction close to or away from the thin film.

In the embodiments, the spacer can be the thin film, the thin film roll can be supported by means of the supporting frame, the thin film is clamped by the film clamping member so as to be pulled out, the first film covering driving mechanism drives the thin film cutting member to move to cut off the thin film, thus separating the thin film and the thin film roll; and the clamping jaw can wash the adsorption member by the separated thin film, the thin film and the waste attached to the thin film are directly removed and recycled correspondingly after washing, and thus the waste scraped off by the scraping and washing mechanism cannot be attached to the clamping jaw. In the embodiments, the influence of the waste polluting the scraping and washing mechanism on subsequent washing can be reduced, and the cleaning to the scraping and washing mechanism is reduced, so that the washing efficiency of washing the adsorption member is improved.

In some embodiments, the cleaning mechanism further includes: a second film covering driving mechanism used for driving the film clamping member to move in a direction close to or away from the adsorption member.

In the embodiments, the second film covering driving mechanism drives the film clamping member to move in the direction close to the adsorption member so that the thin film can be pulled out from the thin film roll, the cut thin film is conveyed to be between the clamping jaw and the adsorption member, and the film clamping member is driven to move in the direction away from the adsorption member so that the end of the thin film roll can be clamped, and the thin film can be dragged out of the thin film roll by the next action.

In some embodiments, the cleaning mechanism further includes: a third film covering driving mechanism used for driving the film clamping member to clamp or release the thin film.

In the embodiments, the third film covering driving mechanism drives the film clamping member to clamp the thin film so that the thin film can be dragged; and when the clamping jaw passes through the thin film and clamps the adsorption member, the film clamping member is driven to release the thin film so that the clamping jaw can drive the thin film to move so as to wash the adsorption member.

In some embodiments, the film clamping member includes a first clamping member and a second clamping member, in which, the first clamping member is provided with a first clamping surface, the second clamping member is provided with a second clamping surface, and the first clamping surface and the second clamping surface are oppositely arranged and are used for clamping the thin film; and the third film covering driving mechanism is connected to at least one of the first clamping member and the second clamping member and used for driving the first clamping surface and the second clamping surface to be close to or away from each other.

In the embodiments, the first clamping surface and the second clamping surface are oppositely arranged on two sides of the thin film, the third film covering driving mechanism drives the first clamping surface and the second clamping surface to be close to or away from each other so as to clamp and release the thin film.

In some embodiments, the first clamping member includes a first connecting arm and a first clamping portion, in which, the first connecting arm is connected to the output end of the third film covering driving mechanism, and the first connecting arm and the second clamping member are arranged at an interval in the clamping direction; the first clamping portion is connected to the first connecting arm, and extends in a direction close to the second clamping member; and the first clamping portion is provided with the first clamping surface.

In the embodiments, the first connecting arm is arranged and is convenient to convey the thin film to be between the clamping jaw and the adsorption member.

In some embodiments, the first clamping portion includes a first section and a second section which are connected in a bent mode, in which, the second section is connected to the first connecting arm by the first section, and the first section extends in the clamping direction of the first connecting arm and the second clamping member.

In the embodiments, the first clamping portion includes the first section and the second section which are connected in a bent mode, and the first section is arranged on the outer side of the thin film to limit the thin film.

In some embodiments, two film clamping members are oppositely arranged and used for clamping two sides of the thin film respectively, and the clamping jaw is located between the two film clamping members.

In the embodiments, the two film clamping members clamp the two sides of the thin film respectively so that the thin film can be opened and move in parallel, the clamping jaw is located between the two film clamping members and faces the thin film, and the clamping jaw can clamp the thin film on the adsorption member when stretching out.

In some embodiments, the cleaning mechanism further includes at least one roller shaft, a compressing plate and a film pressing member. The roller shaft is used for supporting the thin film between the supporting frame and the film clamping member; the compressing plate and the film pressing member are oppositely arranged, and the film pressing member is used for compressing the thin film towards the compressing plate.

In the embodiments, the roller shaft is arranged between the supporting frame and the film clamping member to support the thin film that is pulled out of the film roll, thus the thin film is prevented from being folded or deviating to affect work of the device, and the film clamping member can pull out the thin film conveniently; and when cutting the thin film, the thin film is compressed by the film pressing member so that the thin film can be cut off by the film cutting member conveniently, and that the thin film extends to cause failure in cutting is prevented.

In some embodiments, the cleaning mechanism further includes a first sensor which is mounted on the supporting frame, faces the thin film roll and is used for detecting the roll diameter of the thin film roll.

In the embodiments, the roll diameter of the thin film roll is detected by means of the first sensor so as to determine the thin film allowance on the thin film roll, which facilitates in-time replacement of the thin film roll.

In some embodiments, the cleaning mechanism further includes a second sensor which is mounted on the supporting frame, faces a position between the thin film roll and the film clamping member and is used for detecting whether there is the thin film between the thin film roll and the film clamping member.

In the embodiments, whether there is the thin film between the thin film roll and the film clamping member is detected by the second sensor, and if no, it is needed to check the thin film allowance and whether the thin film is broken in time, thereby improving the work stability of the device.

In some embodiments, the cleaning mechanism further includes a third sensor which is mounted on the supporting frame, faces the thin film roll and is used for detecting the rotation state of the thin film roll.

In the embodiments, whether the thin film roll can normally rotate or not is detected by the third sensor, if the thin film roll cannot normally rotate, the pulling-out of the thin film is possibly influenced, it is needed to check in time, thereby improving the work stability of the device.

In some embodiments, the washing device further includes: a second driving mechanism which is used for driving the cleaning mechanism to move in a direction close to or away from the adsorption member.

The cleaning mechanism is driven by the second driving mechanism to be close to the adsorption member so that the adsorption member can be cleaned by the cleaning mechanism conveniently, and the effects of avoiding the adsorption member and reducing a drive tool of the cleaning mechanism can be achieved.

In some embodiments, the washing device further includes: a first supporting member; the cleaning mechanism and the scraping and washing mechanism are both mounted on the first supporting member, and the second driving mechanism is used for driving the first supporting member to move in a direction close to or away from the adsorption member.

In the embodiments, the cleaning mechanism and the scraping and washing mechanism are both mounted on the first supporting member, and the second driving mechanism is used for driving the first supporting member to drive the cleaning mechanism and the scraping and washing mechanism to move in the direction close to or away from the adsorption member, so that the adsorption member can be washed by the scraping and washing mechanism.

In some embodiments, the scraping and washing mechanism further includes: a second scraping and washing driving mechanism which is used for driving the clamping jaw to move in a direction close to or away from the adsorption member.

In the embodiments, the second scraping and washing driving mechanism can drive the clamping jaw to move, and the clamping jaw is driven to move in the direction close to the adsorption member so that the clamping jaw can pass through the thin film and clamp the thin film on the adsorption member for washing. The clamping jaw is driven to move in the direction away from the adsorption member so as to be separated from the adsorption member and to wait for a new thin film in place as well as to wait a next adsorption member to move to a washing position.

In some embodiments, the clamping jaw includes a first jaw body and a first hinge arm which are hinged, a second jaw body and a second hinge arm which are hinged; the first jaw body and the second jaw body are mounted on a support of the scraping and washing mechanism in a pivoted manner, the first hinge arm and the second hinge arm are in sliding fit with the support of the scraping and washing mechanism, and the first scraping and washing driving mechanism is used for driving the first hinge arm and the second hinge arm to slide relative to the support of the scraping and washing mechanism.

In the embodiments, the first jaw body and the second jaw body clamp the adsorption member, and are correspondingly driven to clamp and open by the first hinge arm and the second hinge arm.

In some embodiments, the washing device further includes a waste collecting mechanism and a third driving mechanism. The waste collecting mechanism is used for bearing the waste and the thin film; and the third driving mechanism is used for driving the waste collecting mechanism to move between a storage position and the position below the adsorption member.

In the embodiments, the waste collecting mechanism is driven by the third driving mechanism to move to be below the adsorption member, the waste collecting mechanism can bear and recycle the falling thin film and the waste attached to the thin film, so as to prevent the thin film or the waste from polluting a station; and after washing is finished, the waste collecting mechanism can be driven to move to the storage position so as to avoid the adsorption member.

In a second aspect, the present application further provides an impurity removal system, which includes: an impurity removal chamber used for accommodating to-be-treated slurry; an adsorption member which is arranged corresponding to the impurity removal chamber and used for adsorbing waste in the to-be-treated slurry; and the washing device in any one of the above embodiment and used for washing the waste attached to the adsorption member.

According to the technical solution in the embodiment of the present application, the impurity removal system includes the washing device in any one of the above embodiments, thus in this embodiment, the waste scraped off by the clamping jaw of the scraping and washing mechanism using the thin film cannot be attached to the clamping jaw, the influence of the waste polluting the scraping and washing mechanism on subsequent washing can be reduced, the cleaning to the scraping and washing mechanism is reduced, and accordingly the washing efficiency of washing the adsorption member is improved.

In some embodiments, the impurity removal system further includes a lifting device which is in power coupling connection with the adsorption member and used for driving the adsorption member to be separated from the impurity removal chamber.

In the embodiments, the adsorption member is driven by the lifting device to lift up so as to be separated from the impurity removal chamber, so that the adsorption member is conveniently washed by the washing device.

In a third aspect, the present application further provides a washing method using the washing device in any one of the above embodiments, and the method includes:
outputting the spacer to the clamping jaw;
opening the clamping jaw;
driving the clamping jaw to clamp the spacer to the adsorption member; and
driving the clamping jaw to move in an axial direction of the adsorption member so as to scrape off the waste attached to the adsorption member.

In this embodiment, the spacer is outputted by the cleaning mechanism, the waste scraped off by the clamping jaw of the scraping and washing mechanism using the spacer cannot be attached to the clamping jaw of the scraping and washing mechanism, thus the influence of the waste polluting the scraping and washing mechanism on subsequent washing can be reduced, the cleaning to the scraping and washing mechanism is reduced, and accordingly the washing efficiency of washing the adsorption member is improved.

In some embodiments, the spacer is the thin film, and the outputting the spacer to the clamping jaw includes:
clamping one end of the thin film by the film clamping member of the washing device; and
cutting off the other end of the thin film by the film cutting member of the washing device.

In the embodiments, one end of the thin film is clamped by the clamping member, and the other end of the thin film is cut off by the film cutting member, so that the output of the thin film is achieved; and the film clamping member clamps one end of the thin film so as to convey the thin film to the clamping jaw for use.

In some embodiments, the driving the clamping jaw to move in an axial direction of the adsorption member so as to scrape off the waste attached to the adsorption member includes:
driving the clamping jaw to move in the axial direction of the adsorption member to the exterior of the adsorption member.

In the embodiments, the clamping jaw drives the spacer to move to the exterior of the adsorption member, so that the whole adsorption member is washed, the spacer and the adsorption member are separated, and impurities removed by washing are prevented from adhering to the adsorption member again.

The above description is only an overview of the technical solution of the present application, and in order to be able to understand more clearly the technical means of the present application, it can be implemented in accordance with the contents of the description, and in order to make the above and other purposes, characteristics and advantages of the present application more obvious and easy to understand, the specific embodiments of the present application are listed below.

### BRIEF DESCRIPTION OF DRAWINGS

In order to more clearly illustrate the technical solutions of the embodiments of the present application, the accompanying drawings that need to be used in the embodiments will be briefly introduced below, and it is to be understood that the following accompanying drawings only show some embodiments of the present application and therefore should not be regarded as limiting the scope. For those skilled in the art, other relevant accompanying drawings can also be obtained based on these accompanying drawings without creative work.

FIG. 1 is a schematic structural diagram 1 of an impurity removal system provided by some embodiments of the present application;

FIG. 2 is an exploded schematic structural diagram 1 of an impurity removal device provided by some embodiments of the present application;

FIG. 3 is a schematic structural diagram 1 of an impurity removal device provided by some embodiments of the present application;

FIG. 4 is a schematic sectional structural diagram 1 of an impurity removal device provided by some embodiments of the present application;

FIG. 5 is a partial enlarged diagram of a part A in FIG. 4;

FIG. 6 is a schematic structural diagram 1 of a washing device provided by some embodiments of the present application;

FIG. 7 is a schematic structural diagram 2 of a washing device provided by some embodiments of the present application;

FIG. 8 is a partial enlarged diagram of a part B in FIG. 7;

FIG. 9 is a schematic diagram 1 of a film clamping state of a film clamping member provided by some embodiments of the present application;

FIG. 10 is a schematic diagram 2 of a film clamping state of a film clamping member provided by some embodiments of the present application;

FIG. 11 is a schematic diagram of a state of a clamping jaw clamping a thin film provided by some embodiments of the present application;

FIG. 12 is a schematic structural diagram 1 of a scraping and washing mechanism provided by some embodiments of the present application;

FIG. 13 is a flowchart 1 of a cleaning method provided by some embodiments of the present application; and

FIG. 14 is a flowchart 1 of a washing method provided by some embodiments of the present application.

### DESCRIPTION OF REFERENCE NUMERALS

100: impurity removal system, 110: impurity removal chamber, 120: adsorption member, and 130: first driving mechanism;
200: impurity removal device, 201: positioning mechanism, 202: positioning rod, 203: buffer device, 204: buffer head, 205: damper, 206: first bearing, 207: second bearing, and 208: third bearing;
210: supporting structure, 211: supporting member, 212: avoiding port, 213: supporting portion, 214: fixing member, 215: fixing member avoiding hole, 216: connecting structure, 217: spring seat, 218: bolt, and 219: mounting bracket;
220: adsorption assembly, 221: mounting member, 222: positioning groove, 223: adsorption driving mechanism, and 224: transmission shaft;
230: cover body; 231: cover plate; 232: first avoiding hole, 233: second avoiding hole for cover body, 234: connecting groove, 235: locking member, 236: blocking portion, 237: cover body driving mechanism, 238: telescopic cylinder, and 239: connecting rod;
300: washing device, and 301: first supporting member;
310: cleaning mechanism, 311: supporting frame, 312: film clamping member, 3121: first clamping member, 31211: first connecting arm, 31212: first clamping portion, 31212a: first section, 31212b: second section, 3122: second clamping plate, 313: compressing plate, 3131: gap, 314: film cutting member, 315: film pressing member, 316: first film covering driving mechanism, 317: second film covering driving mechanism, 318: third film covering driving mechanism, and 319: fourth film covering driving mechanism;
320: thin film roll, 321: thin film, 322: roller shaft, and 323: damper;
330: scraping and washing mechanism, 331: clamping jaw, 3311: first jaw body, 3312: first hinge arm, 3313: second jaw body, 332: first scraping and washing driving mechanism, and 333: second scraping and washing mechanism;
341: first sensor, 342: second sensor, and 343: third sensor; and
350: waste collecting mechanism.

### DETAILED DESCRIPTION

In order to make the objects, technical solutions and advantages of embodiments of the present application clearer, the technical solutions in the embodiments of the present application will be clearly described below with reference to the drawings for the embodiments of the present application. Apparently, the described embodiments are some of, rather than all of, the embodiments of the present application. All the other embodiments obtained by a person of ordinary skill in the art based on the embodiments of the present application without any creative effort shall fall within the scope of protection of the present application.

Unless otherwise defined, all technical and scientific terms used in the present application shall have the same meanings as those generally understood by those skilled in the art of the present application. The terms used in the present application in the specification of application are merely for the purpose of describing specific embodiments and are not intended to limit the present application. The terms “include” and “have” and any variations thereof in the specification and claims and the above brief description of the drawings of the present application are intended to cover non-exclusive inclusion. The terms “first,” “second,” etc. in the specification and the claims of the present application as well as the above drawings are used to distinguish different objects, rather than to describe a specific order or primary-secondary relationship.

The phrase “embodiment” referred to in the present application means that the descriptions of specific features, structures, and characteristics in combination with the embodiment are included in at least one embodiment of the present application. The appearance of this phrase in various places in the specification does not necessarily refer to the same embodiment, nor is it a separate or alternative embodiment that is mutually exclusive with other embodiments. It is understood explicitly and implicitly by those skilled in the art that the embodiments described in the present application can be combined with other embodiments.

In the description of the present application, it should be noted that the terms “mounting”, “connecting”, “connection” and “attachment” should be understood in a broad sense, unless otherwise explicitly specified or defined, for example, it may be a fixed connection, a detachable connection or an integrated connection; and may be a direct connection or an indirect connection through an intermediate medium, or may be a communication between the interior of two elements. For those of ordinary skill in the art, the specific meanings of the above terms in the present application can be understood according to specific situations.

In the present application, the term “and/or” is only an association relation describing associated objects, which means that there may be three relations, for example, A and/or B may represent three situations: A exists alone, both A and B exist, and B exists alone. In addition, the character “/”' in the present application generally means that the associated objects before and after it are in an “or” relationship. In this disclosure, unless otherwise specified, phrases like “at least one of A, B, and C” and “at least one of A, B, or C” both mean only A, only B, only C, or any combination of A, B, and C.

In the present application, the term “a plurality of” refers to more than two (including two), similarly, “a plurality of groups” refers to two or more groups (including two groups), and “a plurality of pieces” refers to more than two pieces (including two pieces).

From the perspective of current development of the market situation, the application of power batteries is becoming more and more extensive. Power batteries are not only used in energy storage power systems such as hydropower, thermal power, wind power and solar power stations, but also widely used in electric vehicles such as electric bicycles, electric motorcycles, and electric vehicles, as well as military equipment and aerospace and other fields. With the development of electric vehicles, as well as military equipment and aerospace, power batteries have become the key to the sustainable development of the automotive industry. For e-mobility, as well as military equipment and aerospace, power battery technology is an important factor in development. The production process of the power batteries includes the production of slurry.

The applicant noted that at present, in the production process of slurry, the slurry is easy to be polluted by impurities such as iron, and when the slurry is coated on a substrate in the future, the iron and other impurities in the slurry will scratch the substrate and affect the coating effect of the slurry. In order to reduce the impurities in the slurry, an iron remover may be used for iron removing and filtration. But the current iron remover works in a manual washing way, which is time-consuming and labor-intensive, and on the one hand, manual washing is easy to cause slurry splashing to pollute the environment; and on the other hand, due to the presence of corrosive substances in the slurry, manual washing has potential safety hazards. In addition, in the related technology, in the operating processing, the iron remover is easily polluted by the impurities to affect subsequent washing, resulting in the low washing efficiency of the iron remover.

The applicant noted that in order to remove impurities such as iron in the slurry, in the related technology, a magnetic bar is required to absorb magnetic impurities such as iron in the slurry, and it is needed to wash the magnetic bar to remove waste such as iron on the magnetic bar after adsorption. But there will always be some waste residue on the magnetic bar after washing by an existing magnetic bar washing mechanism, and it is often needed to be washed for a long time, but the washing effect is not ideal.

In order to solve the above problems, the applicant found that the existing magnetic bar washing mechanism mainly uses a scraper mechanism which sleeves the magnetic bar to move up and down to realize the scraping of the waste on the magnetic bar. However, in this mode, when the scraper mechanism retracts upwards, the waste attached to the scraper mechanism will re-pollute the cleaned magnetic bar, resulting in low magnetic bar washing efficiency.

In view of above, in order to improve the washing efficiency of the magnetic bar, the applicant has designed a washing device and an impurity removal system after in-depth research, and the waste on the magnetic bar will not be attached to a scraping mechanism after being scraped off by a spacer, which can reduce the possibility of subsequent washing due to the waste polluting the scraping and washing mechanism, thereby reducing the cleaning times of the scraping and washing mechanism, and improving the washing efficiency and washing effect of washing an adsorption member.

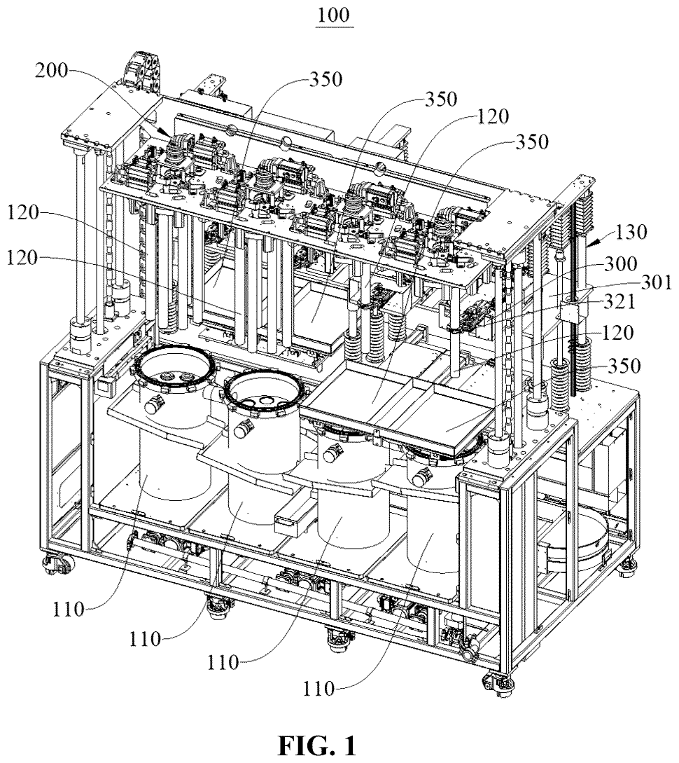

According to some embodiments of the present application, as shown in FIG. 1. FIG. 1 is a schematic structural diagram 1 of an impurity removal system 100 provided by some embodiments of the present application.

The present application provides an impurity removal system 100, which can include an impurity removal chamber 110, an impurity removal device 200 and a washing device 300. The impurity removal chamber 110 is used for accommodating to-be-treated slurry. An adsorption member 120 of the impurity removal device 200 is arranged corresponding to the impurity removal chamber 110 and used for adsorbing waste in the to-be-treated slurry. The washing device 300 is used for washing the waste attached to the adsorption member 120.

It is to be noted that this solution is suitable for a plurality of scenarios, and it is described here by taking the adsorption member 120 as a magnetic bar and the impurity removal chamber 110 as an iron removal chamber.

At least one impurity removal channel can be arranged in the impurity removal chamber 110 and used for accommodating the to-be-treated slurry and enabling the to-be-treated slurry to flow along the impurity removal channel, and the adsorption member 120 is correspondingly arranged in the impurity removal channel to adsorb the to-be-treated slurry flowing through the impurity removal channel for iron removal.

A plurality of impurity removal channels can be arranged in the impurity removal chamber 110, two ends of the plurality of impurity removal channels are in corresponding communication, and by arranging the plurality of impurity removal channels, the capacity of the impurity removal chamber 110 is improved; and a plurality of adsorption members 120 of the impurity removal device 200 can be arranged corresponding to the impurity removal channels of the impurity removal chamber 110, thus improving the iron removal efficiency. In this embodiment, the impurity removal system 100 can further include a lifting device which is in power coupling connection with the impurity removal device 200 and used for driving the impurity removal device 200 to lift up and down. The lifting device can include a first lifting cylinder and a lifting rail. By taking the direction in the figure as an example, the lifting device is used for moving the impurity removal device 200 up and down along the lifting rail so that the impurity removal device 200 can be separated from the impurity removal chamber 110 conveniently, and the adsorption members 120 are washed by the washing device 300.

In actual implementation, after the impurity removal device 200 removes iron in the impurity removal chamber 110 for a period of time, the lifting device will drive the impurity removal device 200 to move upwards, and thus the corresponding adsorption member 120 is driven to be separated from the impurity removal chamber 110; and after the adsorption member 120 is washed by the washing mechanism, the lifting device will drive the impurity removal device 200 to move downwards, so that the adsorption member 120 extends into the impurity removal channel of the impurity removal chamber 110 to continue to remove iron.

After the adsorption member 120 perform adsorption for a period of time, it is needed to clean the waste on the adsorption member 120 so as to improve the adsorption efficiency of the adsorption member 120. After the waste attached to the adsorption member 120 is washed by the washing device 300, the adsorption member 120 will restore to an initial state and then extends into the corresponding impurity removal channel to adsorb the to-be-treated slurry, and therefore, the treatment efficiency and effect of the to-be-treated slurry are guaranteed.

It is to be noted that the waste in this embodiment may include magnetic substances and magnetic liquid. The adsorption members 120 may be the magnetic bars, and the magnetic bars can adsorb the magnetic substances or the magnetic liquid.

In some embodiments, the impurity removal system 100 can include a plurality of impurity removal chambers 110, and the impurity removal chambers 110 are connected end to end. Two impurity removal chambers 110 located at the head and the tail are connected to a feeding pipe and a discharging pipe correspondingly, the to-be-treated slurry needs to sequentially flow through the impurity removal chambers 110 so as to be subjected to multi-stage iron removal purification treatment.

The impurity removal system 100 can be provided with a plurality of impurity removal devices 200, and the impurity removal devices 200 are in one-to-one correspondence with the impurity removal chambers 110 and are used for removing iron in the impurity removal chambers 110, so that the to-be-treated slurry is subjected to multi-stage iron removal, and the iron removal effect is improved.

It is to be noted that the waste in this embodiment may include magnetic substances and magnetic liquid. The adsorption members 120 may be the magnetic bars, and the magnetic bars can adsorb the magnetic substances or the magnetic liquid.

In some embodiments, the impurity removal system 100 can include a plurality of washing devices 300. After the adsorption members 120 perform adsorption for a period of time, it is needed to clean the waste on the adsorption members 120 so as to improve the adsorption efficiency of the adsorption members 120. After the waste attached to the adsorption member 120 is washed by the washing device 300, the adsorption member 120 will restore to an initial state and then extends into the corresponding impurity removal channel to adsorb the to-be-treated slurry, and therefore, the treatment efficiency and effect of the to-be-treated slurry are guaranteed.

In one example, the impurity removal system 100 can include a plurality of impurity removal devices 200 and a plurality of washing devices 300, in which, the impurity removal devices 200 correspond to the washing devices 300 in a one-to-one mode, and the adsorption members 120 of the corresponding impurity removal devices 200 are washed by the washing devices 300.

In another example, the impurity removal system 100 can include a plurality of impurity removal devices 200 and a plurality of washing devices 300; the impurity removal devices 200 can be provided with a plurality of adsorption members 120, in which, each impurity removal device 200 corresponds to at least two washing devices 300, and the two adsorption members 120 of the impurity removal device 200 are washed at the same time by the two washing devices 300, thereby improving the washing efficiency.

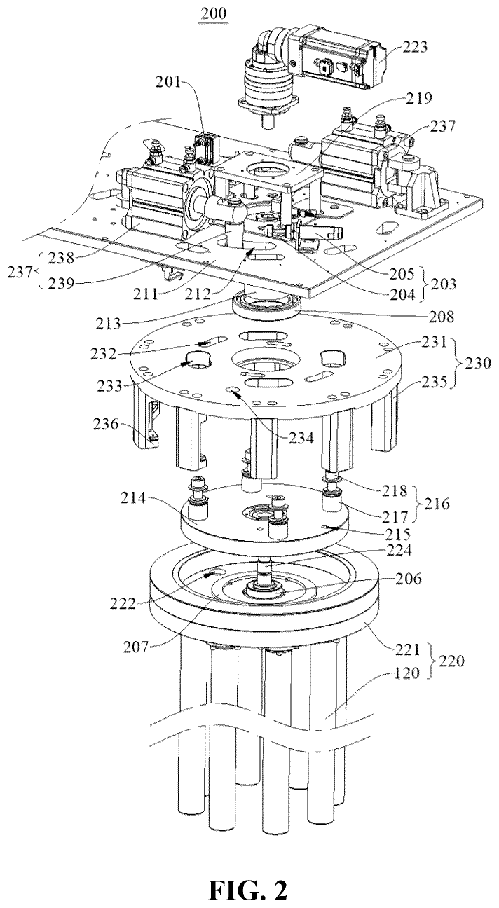

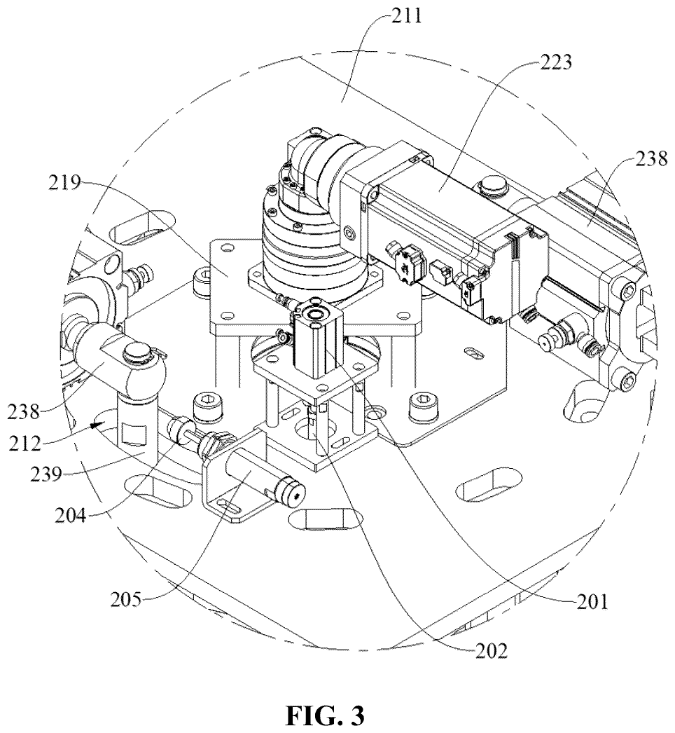

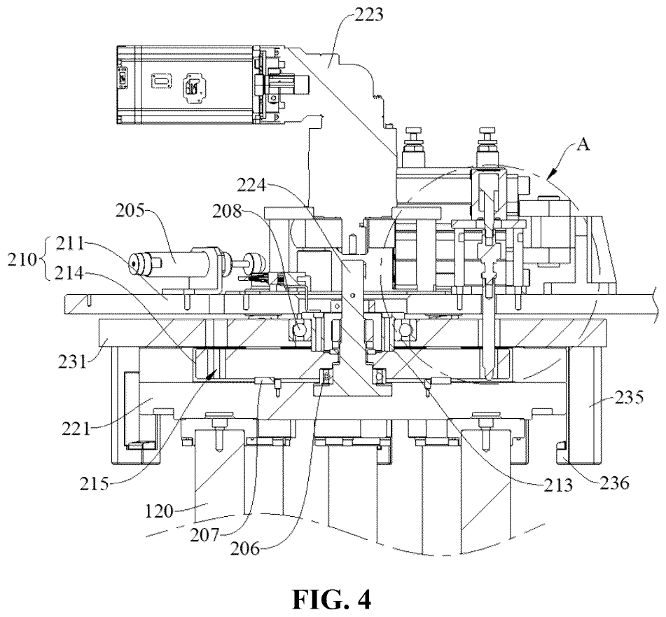

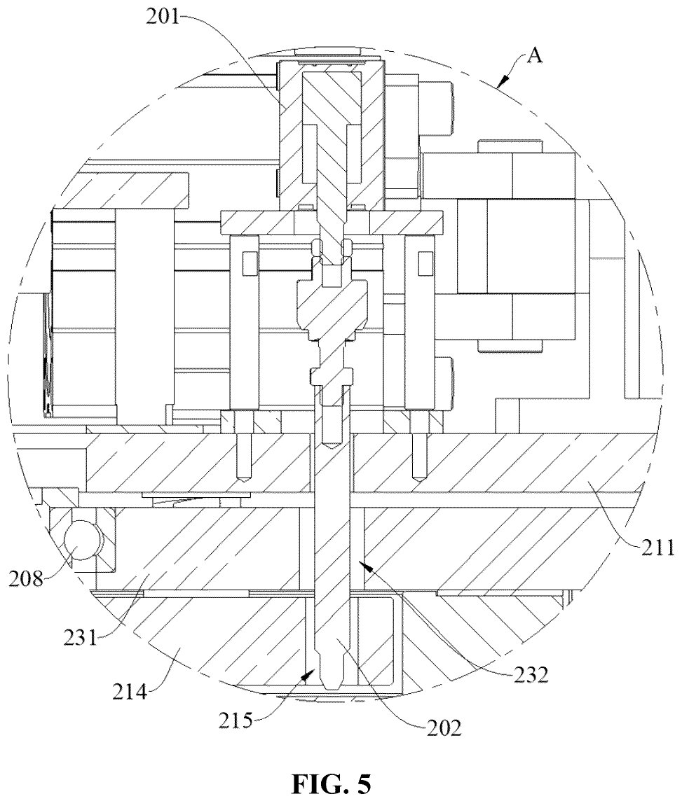

As shown in FIG. 2 to FIG. 5, FIG. 2 is an exploded schematic structural diagram 1 of an impurity removal device provided by some embodiments of the present application; FIG. 3 is a schematic structural diagram 1 of an impurity removal device provided by some embodiments of the present application; FIG. 4 is a schematic sectional structural diagram 1 of an impurity removal device provided by some embodiments of the present application; and FIG. 5 is a partial enlarged diagram of a part A in FIG. 4.

In another aspect, the present application provides the impurity removal device 200.

According to some embodiments of the present application, as shown in FIG. 2 to FIG. 4, the impurity removal device 200 includes an adsorption assembly 220 and an adsorption driving mechanism 223.

The adsorption assembly 220 includes a plurality of adsorption members 120 used for adsorbing waste in to-be-treated slurry.

The plurality of adsorption members 120 correspond to a plurality of impurity removal channels in the impurity removal chamber 110; and the adsorption members 120 correspond to the impurity removal channels in shape and are in clearance fit with the impurity removal channels, so that after the adsorption members 120 extend into the impurity removal channels, the to-be-treated slurry can only flow through gaps between the adsorption members 120 and inner walls of the impurity removal channels, which increases the contact area between the to-be-treated slurry and the adsorption members 120, and improves the adsorption iron removal efficiency.

An output end of the adsorption driving mechanism 223 is connected to the adsorption assembly 220 and used for driving the adsorption assembly 220 to rotate.

In the embodiments, the adsorption driving mechanism 223 can be a driving motor which can) be a servo motor, and an output end of the driving motor can be provided with a speed reducer; and the adsorption driving mechanism 223 is in power coupling connection with the adsorption assembly 220 by the speed reducer so as to drive the adsorption assembly 220 to rotate and to control the precision of the rotating angle.

The plurality of adsorption members 120 can be distributed in the circumferential direction of the adsorption assembly 220; the washing device 300 of the impurity removal system 100 is difficult to directly wash all the adsorption members 120 at a time, the output end of the adsorption driving mechanism 223 drives the adsorption assembly 220 to rotate, then the plurality of adsorption members 120 are driven to rotate, thus the adsorption members 120 facing the washing device 300 of the impurity removal system 100 can be adjusted, and the adsorption members 120 can be washed by the washing device 300.

In actual implementation, when the lifting device drives the impurity removal device 200 to move to a to-be-washed position, the washing device 300 of the impurity removal system 100 will wash the corresponding adsorption member 120; after the adsorption member 120 is washed, the adsorption driving mechanism 223 will drive the adsorption assembly 220 to rotate by a certain angle, so that the next adsorption member 120 adjacent to this adsorption member 120 faces the washing device 300, and is washed by the washing device 300, and so on. It is to be understood that when the impurity removal device 200 corresponds to two or more washing devices 300, the two washing devices 300 can clean two adsorption members 120 at the same time, and the adsorption driving mechanism 223 can drive the adsorption assembly 220 to rotate until the two adjacent adsorption members 120 face the two washing devices 300.

According to the impurity removal device 200 provided by the embodiment of the present application, the adsorption assembly 220 is driven to rotate to adjust relative positions of the plurality of adsorption members 120, so that the plurality of adsorption members 120 on the adsorption assembly 220 can be washed in sequence, the washing effect on the adsorption members 120 can be improved, the effect of simplifying the washing device or saving manpower is achieved, the washing efficiency and the washing effect are improved, and the production cost is reduced.

As shown in FIG. 2 to FIG. 4, the impurity removal device 200 provided by some embodiments of the present application can further include a supporting structure 210 and a positioning mechanism 201.

The adsorption driving mechanism 223 can be mounted on the supporting structure 210, and the adsorption assembly 220 can be rotationally mounted on the supporting structure 210.

The supporting structure 210 can be used for supporting the adsorption driving mechanism 223 and the adsorption assembly 220, the adsorption driving mechanism 223 and the adsorption assembly 220 can be arranged on two opposite sides of the supporting structure 210 correspondingly, and an output end of the adsorption driving mechanism 223 penetrates through the supporting structure 210 to be in power coupling connection with the adsorption assembly 220 so as to drive the adsorption assembly 220 to rotate.

The positioning mechanism 201 can be mounted on the supporting structure 210, the adsorption assembly 220 can be provided with a positioning matching portion; and under the condition that the adsorption assembly 220 rotates to a target position, the positioning mechanism 201 can be matched with the positioning matching portion.

The positioning mechanism 201 can determine whether the adsorption assembly 220 rotates to the target position or not in a mode of being matched with the positioning matching portion, if the positioning mechanism 201 can be matched with the positioning matching portion, it is determined that the adsorption assembly 220 rotates to the target position, and if the positioning mechanism 201 cannot be matched with the positioning matching portion, it is determined that the adsorption assembly 220 does not rotate to the target position. In this embodiment, the target position refers to the initial position of the adsorption member 220 after separating from the impurity removal chamber 110 and before rotating.

In actual implementation, the plurality of adsorption members 120 on the adsorption assembly 220 correspond to the plurality of impurity removal channels in the impurity removal chamber 110 one to one, and although the adsorption members 120 are in clearance fit with the impurity removal channels, the fit clearance is small. After the adsorption assembly 220 is washed, it is needed to place the plurality of adsorption members 120 back into the plurality of impurity removal channels; due to the existence of machining and assembling tolerance, if the adsorption members 120 do not return into the corresponding impurity removal channels, interference is likely to be caused, the positions are not completely the same after rotation each time, and therefore after each adsorption member 120 is washed, it is needed to reverse the adsorption assembly 220 to the initial position, namely the target position, so that the plurality of adsorption members 120 correspond to the impurity removal channels one to one, and then the positioning mechanism 201 is matched with the positioning matching portion to determine whether the adsorption assembly 220 moves to the target position or not, and the adsorption assembly 220 is kept at the target position.

According to the positioning mechanism 201 provided by the embodiments of the present application, the positioning mechanism 201 is matched with the positioning matching portion, thus that the machining and assembling errors make the adsorption members 120 interfere with the impurity removal chamber 110 to damage devices can be avoided, the durability and the iron removal efficiency of iron removal device are improved.

In some embodiments, the impurity removal device 200 can further include a positioning mounting bracket, the positioning mechanism 201 can be mounted on the positioning mounting bracket, and the positioning mounting bracket and the supporting structure 210 are arranged at an interval. The adsorption driving mechanism 223 can be mounted on the supporting structure 210.

As shown in FIG. 2, FIG. 4 and FIG. 5, according to some embodiments of the present application, the positioning matching portion can be a positioning slot 222 formed in an upper surface of the adsorption assembly 220, the positioning mechanism 201 can be provided with a telescopic positioning rod 202, and the positioning rod 202 is suitable for extending into the positioning slot 222. It is to be noted that in the states shown in FIG. 4 and FIG. 5, the positioning rod 202 is located at a position without extending into the positioning slot 222.

The positioning matching portion can be the positioning slot 222 formed in the upper surface of the adsorption assembly 220, the positioning mechanism 201 can include a positioning cylinder, the positioning rod 202 is telescopically mounted on the positioning cylinder and used for driving the positioning rod 202 to be telescopically arranged; and under the condition that the adsorption assembly 220 rotates to the target position, the positioning rod 202 can extend into the positioning slot 222, so that the adsorption assembly 220 cannot rotate relatively.

In this embodiment, the positioning rod 202 can be a round rod, the positioning slot 222 can be a round groove, the positioning rod 202 and the positioning slot 222 can be in clearance fit, and the fit tolerance is smaller than the fit tolerance of the adsorption members 120 and the impurity removal channels. In other embodiment, the positioning rod 202 and the positioning slot 222 can be in other shape such as a square shape and a rhombus shape, which is not limited here.

As shown in FIG. 2, FIG. 4 and FIG. 5, according to some embodiments of the present application, the impurity removal device 200 can further include a cover body 230. The cover body 230 can be used for sealing the impurity removal chamber 110 of the impurity removal system 100.

It needs to be guaranteed that there is certain pressure in the impurity removal chamber 110 during iron removal, thus the cover body 230 can cover an opening in an upper end of the impurity removal chamber 110 and seal the impurity removal chamber 110.

As shown in FIG. 4 and FIG. 5, the cover body 230 is mounted between the adsorption assembly 220 and the positioning mechanism 201, the cover body 230 is provided with first avoiding hole 232, and the positioning mechanism 201 is suitable for penetrating through the first avoiding hole 232.

In the iron removal process, it is needed to arrange the adsorption assembly 220 in the impurity removal chamber 110, and arrange the positioning mechanism 201 outside the impurity removal chamber 110, so the cover body 230 is mounted between the adsorption assembly 220 and the positioning mechanism 201; and in order to make the positioning mechanism 201 match with the adsorption assembly 220, the first avoiding hole 232 is formed in the cover body 230, so that the positioning mechanism 201 penetrates through the first avoiding hole 232 to be matched with the positioning matching portion of the positioning mechanism 201.

In the actual implementation, when the adsorption assembly 220 rotates to the target position, the positioning matching portion on the adsorption assembly 220 faces the first avoiding holes 232, so that the positioning rod 202 of the positioning mechanism 201 can penetrate through the first avoiding hole 232 to be matched with the positioning matching portion for limiting.

As shown in FIG. 2 and FIG. 4, in some embodiments, two first avoiding holes 232 can be provided, and the two avoiding holes of the cover body 230 are symmetrically formed along a rotating axis of the adsorption assembly 220, which facilitates assembling and debugging to the cover body 230.

As shown in FIG. 2, according to some embodiments of the present application, the first avoiding holes 232 can be in an arc shape with the circle center on the rotating axis of the adsorption assembly 220.

The first avoiding holes 232 are arranged to be in the arc shape, so that the coverage area of the first avoiding holes 232 is increased, which facilitates the alignment of the positioning matching portion and the first avoiding holes 232. Moreover, under the condition that the positioning mechanism 201 is matched with the positioning matching portion, the cover body 230 can rotate within the arc range of the first avoiding holes 232, and thus the cover body 230 and the impurity removal chamber 110 can be locked or unlocked conveniently.

As shown in FIG. 2 to FIG. 5, according to some embodiments of the present application, the supporting structure 210 can include a supporting member 211 and a fixing member 214.

The adsorption driving mechanism 223 can be mounted on the supporting member 211; the supporting member 211 can be connected to a lifting device and is used for driving the adsorption assembly 220 and the adsorption driving mechanism 223 to move in a vertical direction by means of the lifting device. The adsorption driving mechanism 223 is arranged on an upper side of the supporting member 211, and the adsorption assembly 220 is arranged on a lower side of the supporting member 211; a mounting bracket 219 can be arranged on the upper side of the supporting member 211; and the adsorption driving mechanism 223 is mounted on the mounting bracket 219, and the mounting bracket 219 can be spaced from the supporting member 211 by a certain distance, so that the adsorption driving mechanism 223 can be mounted conveniently.

The fixing member 214 can be connected to the supporting member 211, and the adsorption assembly 220 is rotationally mounted on the fixing member 214; the fixing member 214 can be provided with a fixing member avoiding hole 215; and a positioning mechanism 201 is suitable for penetrating through the fixing member avoiding hole 215.

The fixing member 214 can be fixedly connected to the supporting member 211, and the fixing member 214 can be arranged on the lower side of the supporting member 211; the positioning mechanism 201 can be arranged on the upper side of the supporting member 211; and the adsorption assembly 220 is rotationally mounted on the lower side of the fixing member 214. The fixing member 214 can be provided with the fixing member avoiding hole 215, so that the positioning mechanism 201 penetrates through the fixing member 214 to be matched with the positioning matching portion. The fixing member avoiding hole 215 can play a role in correcting the positioning mechanism 201, it needs the positioning mechanism 201 to penetrate through the fixing member avoiding hole 215 and then be matched with the positioning matching portion.

In actual implementation, it needs the adsorption assembly 220 to rotate to the target position after washing is finished, the positioning matching portion is aligned with the fixing member avoiding hole 215, and the positioning mechanism 201 is aligned with the fixing member avoiding hole 215, and then the positioning mechanism 201 can be matched with the positioning matching portion. If the positioning mechanism 201 deviates and cannot be matched with the positioning matching portion by means of the fixing member avoiding hole 215, the system will alarm; and if the adsorption assembly 220 deviates and cannot rotate to the target position, and the positioning mechanism 201 penetrates through the fixing member avoiding hole 215 and then cannot be matched with the positioning matching portion, the system will alarm.

In the embodiments of the present application, the fixing member avoiding hole 215 plays a role of correcting the positioning mechanism 201 and the positioning matching portion, and thus the problem that the impurity removal device 200 starts to fall down before the adsorption assembly 220 moves to the target position due to device tool loss or errors, resulting in interference between the adsorption members 120 and the impurity removal chamber 110 can be avoided.

As shown in FIG. 2 to FIG. 4, according to some embodiments of the present application, the impurity removal device 200 can further include a supporting structure 210, and the adsorption driving mechanism 223 can be mounted on the supporting structure 210. The adsorption assembly 220 can include a mounting member 221 and a plurality of adsorption members 120.

The mounting member 221 is rotationally mounted on the supporting structure 210, the structure of the supporting structure 210 can refer to the above embodiments, the output end of the adsorption driving mechanism 223 is connected to the mounting member 221, and the positioning matching portion is arranged on the mounting member 221.

The output end of the adsorption driving mechanism 223 is in power coupling connection with the mounting member 221 so that the whole adsorption assembly 220 can be driven to rotate. The output end of the adsorption driving mechanism 223 is connected to a transmission shaft 224, the transmission shaft 224 sequentially passes through the supporting member 211, the cover body 230 and the fixing member 214, and therefore the lower end of the transmission shaft 224 is fixedly connected to the mounting member 221; and the transmission shaft 224 and the rotation axis of the mounting member 221 are coaxially arranged so that the mounting member 221 can be driven to rotate.

The plurality of adsorption members 120 are mounted on the mounting member 221 around the rotation axis of the mounting member 221 at intervals.

The plurality of adsorption members 120 are mounted on the mounting member 221 around the rotation axis of the mounting member 221 at intervals, so that the plurality of adsorption members 120 can be conveniently matched with the impurity removal channels of the impurity removal chamber 110, and meanwhile the washing device 300 can conveniently wash the adsorption members 120.

As shown in FIG. 2 to FIG. 4, according to some embodiments of the present application, the supporting structure 210 includes the supporting member 211 and the fixing member 214.

The adsorption driving mechanism 223 can be mounted on the upper side of the supporting member 211, and the mounting member 221 can be mounted on the lower side of the supporting member 211.

The fixing member 214 is connected to the supporting member 211, and the mounting member 221 is rotationally mounted on the fixing member 214 by means of a first bearing 206. The fixing member 214 can be arranged on the lower side of the supporting member 211 and located between the mounting member 221 and the supporting member 211, and the mounting member 221 is rotationally mounted on the fixing member 214 by means of the first bearing 206 so that the mounting member 221 can conveniently rotate relative to the fixing member 214.

In the embodiments, the transmission shaft 224 penetrates through the fixing member 214 to be connected to the mounting member 221, the first bearing 206 is arranged between the transmission shaft 224 and the fixing member 214, and the first bearing 206 can be a rolling bearing; and by the first bearing 206, the stability of the transmission shaft 224 driving the mounting member 221 to rotate can be guaranteed, and shaking or deviation of the mounting member 221 is avoided.

The first bearing 206 can be a plane needle bearing, and a rotating axis of the plane needle bearing and the rotating axis of the mounting member 221 are coaxially arranged, so that the friction resistance is reduced while a pre-tightening force between the mounting member 221 and the fixing member 214 is guaranteed.

As shown in FIG. 2 and FIG. 4, in some embodiments, a second bearing 207 can be arranged between the transmission shaft 224 and the fixing member 214, the second bearing 207 can be a plane needle bearing, and the rotating axis of the plane needle bearing and the rotating axis of the mounting member 221 are coaxially arranged, so that the friction resistance is reduced while the pre-tightening force between the mounting member 221 and the fixing member 214 is guaranteed.

As shown in FIG. 2 and FIG. 4, the impurity removal device 200 can further include the cover body 230.

The cover body 230 can be used for sealing the impurity removal chamber 110 of the impurity removal system 100 and can be mounted between the fixing member 214 and the supporting member 211, the cover body 230 is provided with second avoiding holes 233 for cover body, and a connecting structure 216 between the fixing member 214 and the supporting member 211 penetrates through the second avoiding holes 233 for cover body.

The connecting structure 216 can be arranged between the fixing member 214 and the supporting member 211 and used for connecting the fixing member 214 to the supporting member 211; and because the cover body 230 is arranged between the fixing member 214 and the supporting member 211, the second avoiding holes 233 for cover body are formed for the connecting structure 216 to penetrate through.

In the embodiments, the connecting structure 216 can include a spring seat 217 and a bolt 218, in which, the spring seat 217 can be arranged on the fixing member 214 and used for penetrating into the second avoiding holes 233 for cover body from bottom to top, a mounting hole allowing the bolt 218 to penetrate is formed in the supporting member 211, the bolt 218 penetrates through the mounting hole to be in threaded fit with the spring seat 217, and an upper end of the spring seat 217 abuts against a lower side surface of the supporting member 211 so as to improve the mounting stability of the fixing member 214 and the supporting member 211.

A plurality of connecting structures 216 can be arranged and distributed in the circumferential direction of the fixing member 214 at intervals, and a plurality of second avoiding holes 233 for cover body are formed and correspond to the plurality of connecting structures 216 one to one so as to avoid the plurality of connecting structures 216.

In some embodiments, the second avoiding holes 233 for cover body can be in an arc shape with circle center on the rotating axis of the adsorption assembly 220. The second avoiding holes 233 for cover body are arranged to be in the arc shape so as to avoid the connecting structures 216 between the fixing member 214 and the supporting member 211, and the cover body 230 can be rotationally arranged within the arc range relative to the fixing member 214. The height of the spring seats 217 can be larger than the thickness of the cover body 230 so that the cover body 230 can rotate relative to the supporting member 211 and the fixing member 214.

As shown in FIG. 2, according to some embodiments of the present application, the impurity removal device 200 can further include the cover body 230 and a cover body driving mechanism 237.

The cover body 230 can selectively seal the impurity removal chamber 110 of the impurity removal system 100.

In the embodiments, the cover body 230 can include a cover plate 231 and a locking member 235, in which, the cover plate 231 can be used for covering an opening of the impurity removal chamber 110, and the locking member 235 can be connected to the cover plate 231 and located on the lower side of the cover plate 231; and the locking member 235 can be used for locking the impurity removal chamber 110 so that the cover plate 231 can be in sealed connection with the impurity removal chamber 110. An extending portion extending outwards in a side direction can be arranged at the opening of the impurity removal chamber 110, the locking member 235 can be distributed in the circumferential direction of the cover plate 231, a blocking portion 236 extending towards the inner side of the cover plate 231 can be arranged at the lower end of the locking member 235, and the blocking portion 236 can be matched with the extending portion in a blocked mode.

The output end of the cover body driving mechanism 237 can be in power coupling connection with the cover body 230 and is used for driving the cover body 230 to rotate. The cover body 230 is driven to rotate so as to realize locking and unlocking of the cover body 230 and the impurity removal chamber 110.

In the embodiments, the cover body driving mechanism 237 can be in power coupling connection with the cover plate 231, and the cover plate 231 is driven to rotate so as to drive the locking member 235 to rotate; under the condition that the locking member 235 rotates to the blocking portion 236 to be matched with the extending portion in a blocked mode, the upper surface of the blocking portion 236 abuts against the lower surface of the extending portion, and the cover plate 231 is tightly compressed at an opening of the impurity removal chamber 110, so that locking of the cover body 230 and the impurity removal chamber 110 is realized; and under the condition that the locking member 235 rotates to the blocking portion 236 to be separated from the extending portion, the cover body 230 and the impurity removal chamber 110 are unlocked.

It is to be noted that the first avoiding hole 232 and the second avoiding holes 233 for cover body in the above embodiments can be formed in the cover plate 231.

In the actual implementation, under the condition that it is needed to wash the adsorption member 120, the cover body driving mechanism 237 will drive the cover plate 231 to rotate, then the locking member 235 is driven to be separated from the extending portion to be unlocked, the lifting device drives the impurity removal device 200 to lift up, and thus the cover plate 231 is separated from the impurity removal chamber 110; and after the adsorption member 120 is washed, the lifting device will drive the impurity removal device 200 to lift down, the cover plate 231 covers the opening of the impurity removal chamber 110, the cover body driving mechanism 237 drives the cover plate 231 to rotate reversely, the blocking portion 236 of the locking member 235 is driven to abut against the extending portion, and the cover plate 231 is tightly compressed at the opening of the impurity removal chamber 110, and thus the impurity removal chamber 110 is sealed.

The cover body 230 and the cover body driving mechanism 237 provided by the embodiments of the present application ensure the sealing effect of the impurity removal chamber 110.

As shown in FIG. 2 and FIG. 4, in some embodiments, a plurality of locking members 235 can be provided; a plurality of extending portions can be provided and arranged at intervals in the circumferential direction of the impurity removal chamber 110; the plurality of locking members 235 correspond to the plurality of extending portions one to one; the plurality of locking members 235 can be in clamping fit with the corresponding extending portions, thus improving the locking effect of the cover body 230 and the impurity removal chamber 110; and the cover body 230 can be rotated to enable staggering between the plurality of locking members 235 and the plurality of extending portions, thus unlocking the cover body 230.

As shown in FIG. 2 and FIG. 4, according to some embodiments of the present application, the impurity removal device 200 can further include a supporting member 211.

The cover body driving mechanism 237 can be mounted on the supporting member 211, the cover body 230 is rotationally mounted on the supporting member 211, and the cover body driving mechanism 237 and the cover body 230 can be located on the two sides of the supporting member 211 correspondingly; and the supporting member 211 can be provided with an avoiding port 212, and an output end of the cover body driving mechanism 237 can penetrate through the avoiding port 212 to be in power coupling connection with the cover body 230.

The cover body driving mechanism 237 is mounted on the upper side of the supporting member 211, the cover body 230 is rotationally mounted on the lower side of the supporting member 211, in which, the lower side of the supporting member 211 can be provided with a supporting portion 213, the supporting portion 213 can be arranged in a columnar shape, and an axis of the supporting portion 213 can be collinear with the rotating axis of the cover body 230; a third bearing 208 can be arranged between the cover body 230 and the supporting portion 213; and the rotating stability of the cover body 230 can be guaranteed by the supporting portion 213 and the third bearing 208, and the third bearing 208 can be a rolling bearing.

The supporting member 211 is provided with the avoiding port 212 allowing the output end of the cover body driving mechanism 237 to penetrate through, the output end of the cover body driving mechanism 237 penetrates through the avoiding port 212 to be in power coupling connection with the cover body 230 so as to drive the cover body 230 to rotate to lock and unlock the cover body 230 and the impurity removal chamber 110.

As shown in FIG. 2, FIG. 4 and FIG. 5, according to some embodiments of the present application, the output end of the cover body driving mechanism 237 can include a connecting rod 239, the avoiding port 212 can be in an arc shape with circle center on the rotating axis of the cover body 230, and the connecting rod 239 can be hinged to the cover body 230.

The connecting rod 239 extends in a vertical direction to penetrate through the avoiding port 212 in the vertical direction. The avoiding port 212 can be in an arc shape with circle center on the rotating axis of the cover body 230; the connecting rod 239 is hinged to the cover body 230; and a connecting groove 234 is formed in the cover body 230, and a lower end of the connecting rod 239 can be matched with the connecting groove 234 so that the connecting rod 239 and the cover body 230 can be hinged. The connecting rod 239 is driven to move in the avoiding port 212 along the arc shape so as to drive the cover body 230 to rotate.

As shown in FIG. 2 and FIG. 3, in the embodiments, the cover body driving mechanism 237 can further include a telescopic cylinder 238, one end of the telescopic cylinder 238 can be rotationally connected to the supporting member 211 around the axis in the vertical direction, thus the telescopic cylinder 238 can rotate relative to the supporting member 211, and the other end of each telescopic cylinder 238 can be rotationally connected to the upper end of the connecting rod 239 around the axis of the connecting rod 239. By the telescopic action of the telescopic cylinder 238, the connecting rod 239 is driven to slide in the arc-shaped avoiding port 212, and then the cover body 230 is driven to rotate to be locked and unlocked with the impurity removal chamber 110.

As shown in FIG. 2 and FIG. 3, in some embodiments, a plurality of cover body driving mechanisms 237 can be arranged and distributed in the circumferential direction of the cover body 230, a plurality of avoiding ports 212 are provided corresponding to the plurality of cover body driving mechanisms 237; and the rotating stability and driving force of the cover body 230 can be improved by the plurality of cover body driving mechanisms 237.

As shown in FIG. 2 to FIG. 4, in some embodiments, a buffer device 203 can further be arranged on the supporting member 211 and can be arranged on the upper side of the supporting member 211 to abut against the connecting rod 239 so as to buffer the connecting rod 239.

When the telescopic cylinder 238 is in a retracting state, the connecting rod 239 is located at the end of the avoiding port 212 close to the telescopic cylinder 238; as the telescopic cylinder 238 outwards extends, the connecting rod 239 is driven to slide towards the other end of the avoiding port 212; the buffer device 203 is correspondingly arranged at the other end of the avoiding port 212 to abut against the connecting rod 239 so as to buffer the connecting rod 239 in movement, thus preventing the connecting rod 239 from being damaged.

As shown in FIG. 2 and FIG. 3, in the embodiments, the buffer device 203 includes a buffer head 204 and a damper 205, in which, the buffer head 204 can be made of rubber or plastic and is connected to the damper 205; and when the connecting rod 239 moves to the other end of the avoiding port 212, the buffer head 204 abuts against the connecting rod 239, and the buffer head 204 and the damper 205 have a certain buffer effect on the connecting rod 239.

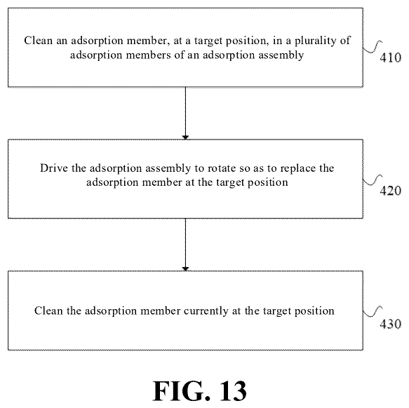

As shown in FIG. 13, in another aspect, the present application provides a cleaning method using the impurity removal device in any one of the above embodiments, the cleaning method can be used for cleaning the impurity removal device 200 and includes:
step 410, cleaning the adsorption member 120, at the target position, in the plurality of adsorption members 120 of the adsorption assembly 220;
step 420, driving the adsorption assembly 220 to rotate so as to replace the adsorption member 120 at the target position; and
step 430, cleaning the adsorption member 120 currently at the target position.

In this embodiment, the adsorption member 120 at the target position can be cleaned by the washing device 300 or in a manual cleaning manner, in which, one or more adsorption members 120 can be at the target position, and more refers to two or more than two, which is subjected to convenience in cleaning by the washing device 300 or manual cleaning, and the number is not limited here. After the adsorption member 120 at the target position is cleaned, the adsorption assembly 220 can be driven to rotate to replace the adsorption member 120 at the target position, and in this process, the washing device 300 and cleaning personnel do not need to move, and are only to clean the un-cleaned adsorption member 120 currently at the target position, and the operation is easy.

In the technical solution of the embodiments of the present application, the adsorption member 120 at the target position is adjusted to be cleaned without the movement of the position of the washing device 300 or the position of the cleaning personnel, so that the washing device 300 is simplified or the labor is saved for cleaning of the adsorption member 120 at the target position, the cleaning efficiency is improved, and the cost is reduced.

According to some embodiments of the present application, the cleaning method further includes:
step 440, driving the adsorption assembly 220 to rotate to the initial position; and
step 450, under the condition that the positioning mechanism 201 of the impurity removal device 200 is matched with the positioning matching portion in place, controlling the adsorption assembly 220 to enter the impurity removal chamber 110.

In the embodiments, the initial position refers to a position state that the adsorption assembly 220 is separated from the impurity removal chamber 110, and in this position state, the plurality of adsorption members 120 of the adsorption assembly 220 can correspond to the impurity removal channels in the impurity removal chamber 110. In the cleaning process of the plurality of adsorption members 120 of the adsorption assembly 220, because there is error when the adsorption assembly 220 rotates, the rotated adsorption members 120 may not correspond to the impurity removal channels by position, which will lead to interference between the adsorption members 120 and the iron removal chamber; the adsorption assembly 220 is driven to rotate to the initial position, so that each adsorption member 120 corresponds to the corresponding impurity removal channel, then the positioning mechanism 201 is matched with the positioning matching portion to determine whether the adsorption assembly 220 accurately reaches the initial position or not, thereby reducing the probability of interference caused by the rotation error of the device; and then the adsorption assembly 220 is controlled to enter the impurity removal chamber 110.

In the technical solution of the embodiments of the present application, the adsorption assembly 220 is rotated to the initial position and is positioned by the positioning mechanism 201, so that the probability of interference between the adsorption assembly 220 and the impurity removal chamber 110 when the adsorption assembly 220 enters the impurity removal chamber 110 is reduced, the working stability of the impurity removal device 200 is improved, and the service life of the impurity removal device 200 is prolonged.

In some embodiments, after step 450, the cleaning method further includes:
step 460, driving the positioning mechanism 201 to restore.

In the embodiments, after the adsorption assembly 220 enters the impurity removal chamber 110, the positioning mechanism 201 can be controlled to restore, and the positioning mechanism 201 is separated from the positioning matching portion, so that when the adsorption assembly 220 rotates for cleaning next time, the positioning mechanism 201 cannot hinder the rotation of the adsorption assembly 220.

According to some embodiments of the present application, before the adsorption assembly 220 of the impurity removal device 200 is separated from the impurity removal chamber 110, the cleaning method further includes:
step 470: driving the cover body of the impurity removal device 200 by the cover body driving mechanism 237 of the impurity removal device 200 to rotate till the cover body and the impurity removal chamber 110 are unlocked.

After the adsorption assembly 220 is controlled to enter the impurity removal chamber 110, the cleaning method further includes:
step 480: driving the cover body of the impurity removal device 200 by the cover body driving mechanism 237 of the impurity removal device 200 to rotate till the cover body and the impurity removal chamber 110 are locked.

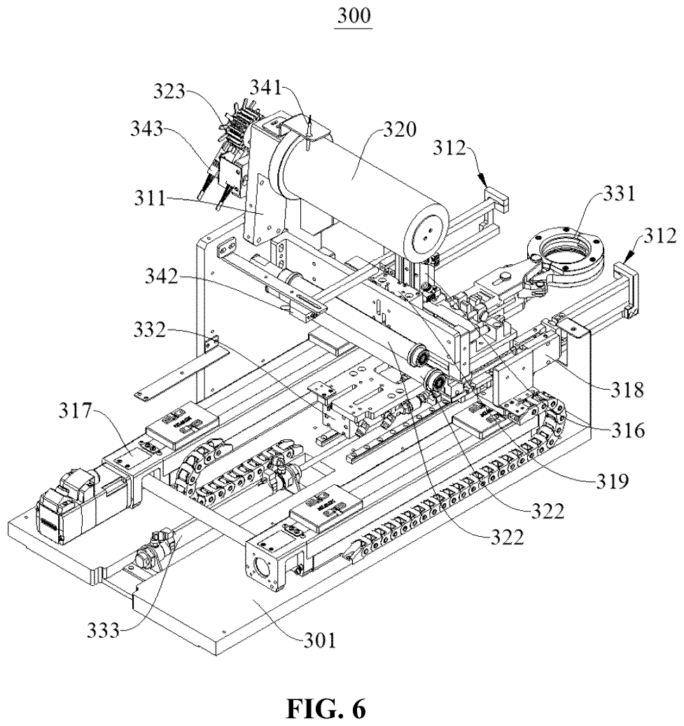

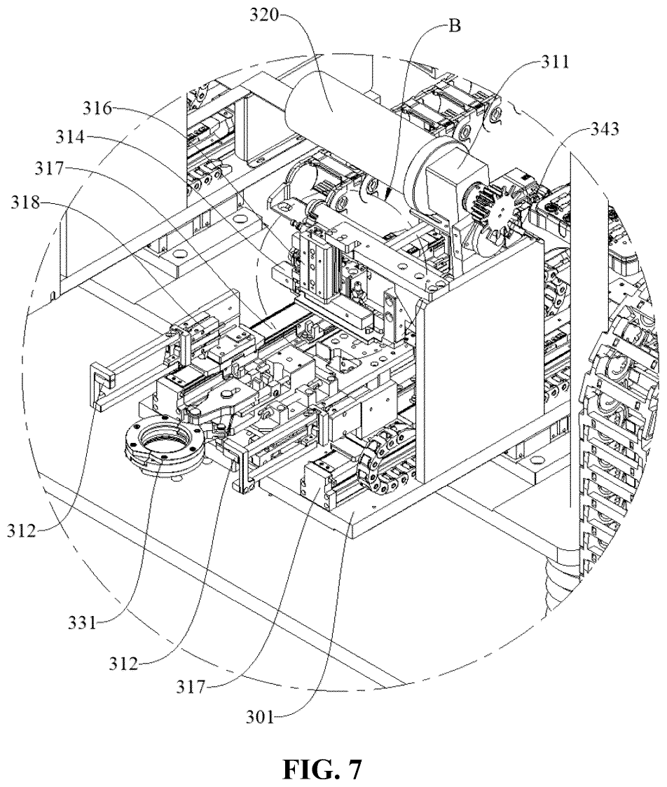

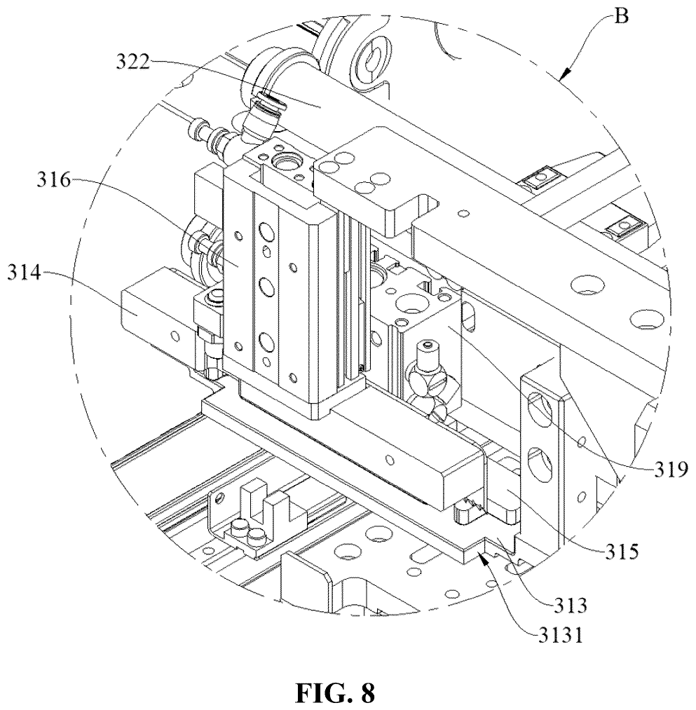

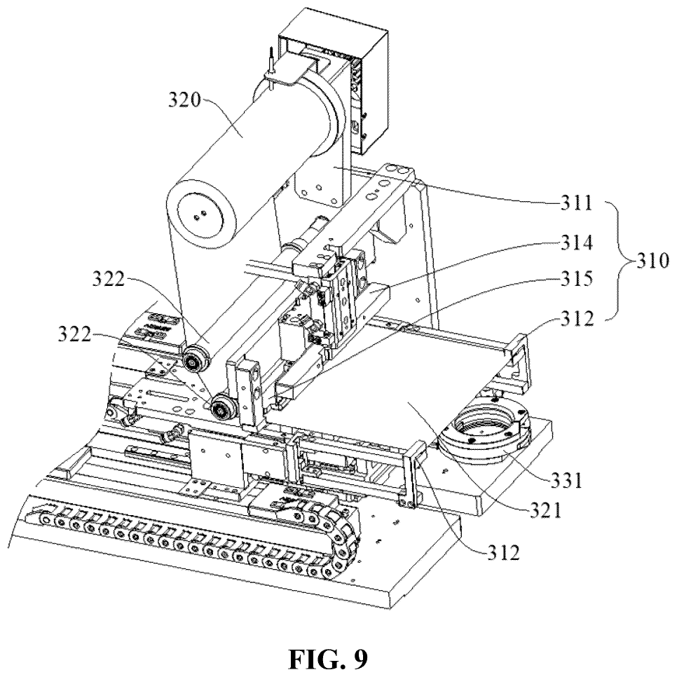

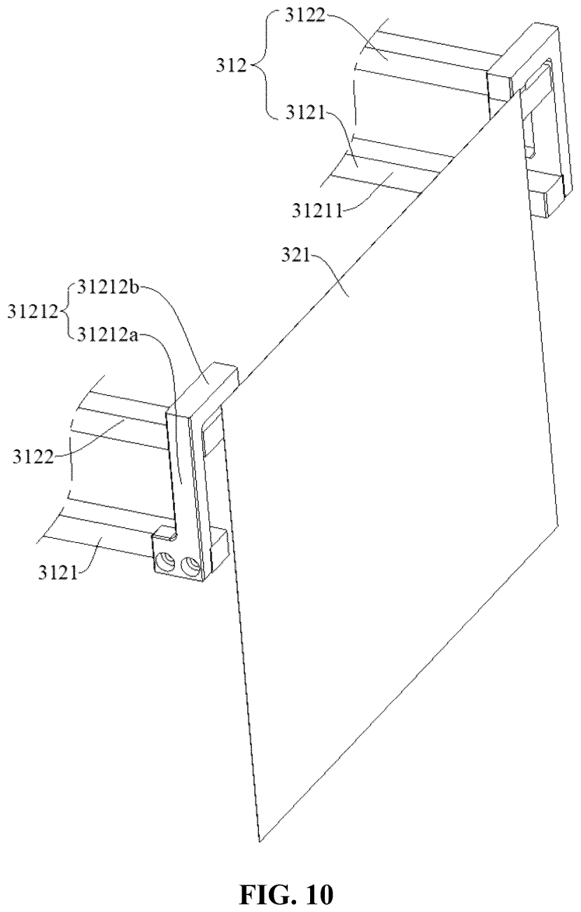

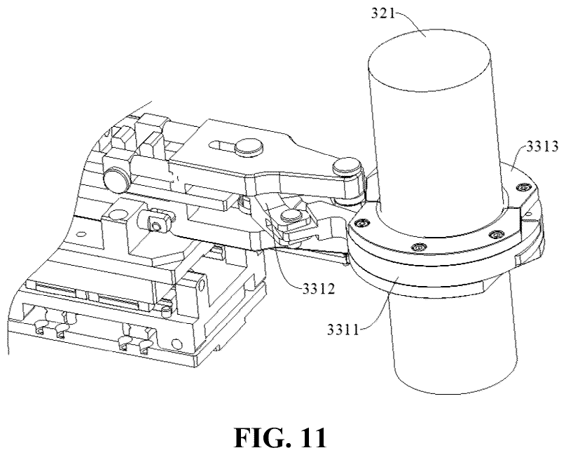

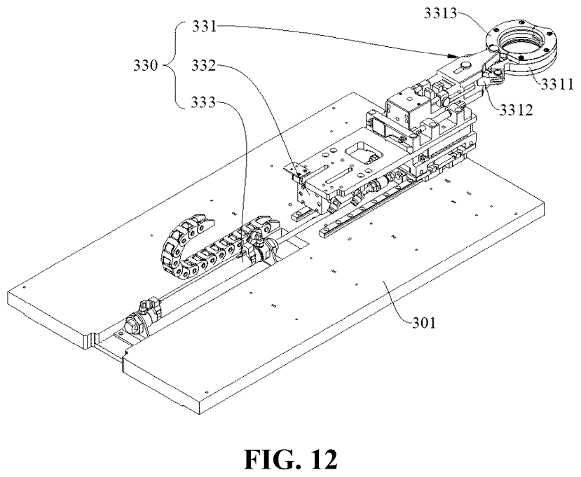

In the technical solution of the embodiments of the present application, the cover body driving mechanism 237 drives the cover body to rotate so as to lock and seal the impurity removal chamber 110, thus facilitating the separation of the cover body and the impurity removal chamber 110, as well as ensuring the sealing performance of the impurity removal chamber 110 in the impurity removal process. As shown in FIG. 6 to FIG. 12, in another aspect, the present application provides the washing device 300. FIG. 6 is a schematic structural diagram 1 of a washing device provided by some embodiments of the present application; FIG. 7 is a schematic structural diagram 2 of a washing device provided by some embodiments of the present application; FIG. 8 is a partial enlarged diagram of a part B in FIG. 7; FIG. 9 is a schematic diagram 1 of a film clamping state of a film clamping member provided by some embodiments of the present application; FIG. 10 is a schematic diagram 2 of a film clamping state of a film clamping member provided by some embodiments of the present application; FIG. 11 is a schematic diagram of a state of a clamping jaw clamping a thin film provided by some embodiments of the present application; and FIG. 12 is a schematic structural diagram 1 of a scraping and washing mechanism provided by some embodiments of the present application.

As shown in FIG. 1, FIG. 6 and FIG. 7, according to some embodiments of the present application, the washing device 300 includes a cleaning mechanism 310, a scraping and washing mechanism 330 and a first driving mechanism 130.

The cleaning mechanism 310 is used for outputting the spacer which can surround and be attached to the surface of the adsorption member 120.

The scraping and washing mechanism 330 includes a clamping jaw 331 and a first scraping and washing driving mechanism 332, in which, the clamping jaw 331 is used for clamping the adsorption member 120 by means of the spacer, and the first scraping and washing driving mechanism 332 is used for driving the clamping jaw 331 to open or clamp.

The clamping jaw 331 of the scraping and washing mechanism 330 is arranged in an opening and closing mode; when the clamping jaw 331 clamps and combines, a clamping space with the shape the same as that of the outer side wall of the adsorption member 120 will be formed in the clamping jaw 331, thus the first scraping and washing driving mechanism 332 can drive the clamping jaw 331 to be clamped on the outer surface of the adsorption member 120; and moreover, the clamping jaw 331 can be attached to the outer surface of the adsorption member 120 so that the clamping jaw 331 can scrape off the waste on the adsorption member 120 during moving.

As shown in FIG. 6, FIG. 7 and FIG. 13, in the embodiments, the clamping jaw 331 can be a clamping jaw cylinder, and the first scraping and washing driving mechanism 332 can be a driving cylinder of the clamping jaw cylinder. In other embodiments, the clamping jaw 331 can be an electric clamping jaw, and the first scraping and washing driving mechanism 332 can be a driving motor of the electric clamping jaw.

When the clamping jaw 331 is clamped on the adsorption member 120 by means of the spacer, the clamping jaw 331 can clamp the spacer between the clamping jaw 331 and the adsorption member 120, so that the spacer is attached to the outer surface of the adsorption member 120, the waste can be attached to the spacer can be scraped off during washing, and as the clamping jaw 331 opens, the waste will fall along with the spacer.

The first driving mechanism 130 is used for driving the scraping and washing mechanism 330 to move in the axial direction of the adsorption member 120 so as to scrape off the waste attached to the adsorption member 120. The scraping and washing mechanism 330 is driven to move in the axial direction of the adsorption member 120 so as to drive the clamping jaw 331 and the spacer to move in the axial direction of the adsorption member 120, and thus the waste on the adsorption member 120 can be scraped off. The first driving mechanism 130 can include a moving rail and a driving cylinder, and the scraping and washing mechanism 330 moves in the axial direction of the adsorption member 120 along the moving rail so that the scraping and washing mechanism 330 can wash the adsorption member 120 conveniently.

In actual implementation, the clamping jaw 331 of the scraping and washing mechanism 330 opens, then the spacer outputted by the cleaning mechanism 310 is located between the clamping jaw 331 and the adsorption member 120, and when the first scraping and washing driving mechanism 332 drives the clamping jaw 331 to clamp, the clamping jaw 331 will be clamped on the outer side wall of the adsorption member 120 by means of the spacer. The first driving mechanism 130 drives the scraping and washing mechanism 330 to move in the axial direction of the adsorption member 120, so as to drive the clamping jaw 331 and the spacer to move from one end of the adsorption member 120 to the outside of the other end of the adsorption member 120 in the axial direction of the adsorption member 120 till the clamping jaw 331 is separated from the adsorption member 120, and the waste attached to the outer side wall of the adsorption member 120 is adhered by the spacer and then is scraped off. The first scraping and washing driving mechanism 332 drives the clamping jaw 331 to open, then the spacer and the waste attached to the spacer fall together, thus the washing action to the adsorption member 120 is completed. Then, the first driving mechanism 130 drives the scraping and washing mechanism 330 to move in the axis direction of the adsorption member 120 and return to the initial position to wait for the next washing action.

According to the washing device 300 provided by the present application, a thin film 321 is outputted by the cleaning mechanism 310, so that the waste scraped off by the clamping jaw 331 of the scraping and washing mechanism 330 using the spacer cannot be attached to the clamping jaw 331 of the scraping and washing mechanism 330, the influence of the waste polluting the scraping and washing mechanism 330 on subsequent washing can be reduced, and it is not needed to clean the scraping and washing mechanism 330, and accordingly the washing efficiency of washing the adsorption member 120 is improved.

In some embodiments, the spacer can also be a sleeve which can sleeve the adsorption member 120 and fit the outer surface of the adsorption member 120; the clamping jaw 331 is clamped on the adsorption member 120 by the sleeve; and the clamping jaw 331 and the adsorption member 120 are isolated by the sleeve, so that the waste are prevented from being attached to the clamping jaw 331.

As shown in FIG. 6 to FIG. 9, according to some embodiments of the present application, the spacer can be the thin film 321, and the cleaning mechanism 310 can include a supporting frame 311, a film clamping member 312, a film cutting member 314 and a first film covering driving mechanism 316.

The thin film 321 can be made of a soft material so as to be attached to the surface of the adsorption member 120 conveniently, and can have a certain adhesion property so as to improve the cleaning effect of the thin film 321 on the waste. In the embodiments, the thin film 321 can be a plastic thin film such as a PE film or a thin film made of rubber and the like, which is not limited here.

The supporting frame 311 can be used for supporting a thin film roll 320. The thin film roll 320 is rotationally mounted on the supporting frame 311, the thin film 321 is wound on the thin film roll 320, and the thin film roll 320 can rotate along with the pulling-out of the thin film 321, so as to prevent the thin film 321 from extending or being broken.

In the embodiments, the supporting frame 311 can be provided with a rotating shaft, the rotating shaft can extend in a horizontal direction, and the thin film roll 320 can sleeve the rotating shaft and rotate along with the rotating shaft. Two ends of the rotating shaft can be provided with limiting portions, and the two limiting portions abut against the two ends of the thin film roll 320 correspondingly to prevent the thin film roll 320 from moving in the axial direction of the rotating shaft and deviating to influence the pulling-out quality of the thin film 321.

The film clamping member 312 can be used for clamping the thin film 321. The film clamping member 312 can be arranged on one side in the radial direction of the thin film roll 320, and in the embodiments, the film clamping member 312 is arranged on the lower side of the thin film roll 320 and can clamp the thin film 321 that is pulled out from the thin film roll 320, and the thin film 321 on the thin film roll 320 is pulled out by the movement of the film clamping member 312.

As shown in FIG. 6 to FIG. 9, in the embodiments, the movement direction of the film clamping member 312 can be vertical to the axis direction of the thin film roll 320, so that the thin film 321 is relatively flat when being pulled out from the thin film roll 320, and the thin film 321 is prevented from being folded or broken due to deviation is avoided.

The film cutting member 314 can be used for cutting off the thin film 321. The film cutting member 314 can be arranged between the thin film roll 320 and the film clamping member 312 and can be provided with a cutter; and after the film clamping member 312 pulls the thin film 321 out from the thin film roll 320, the thin film 321 connected to the thin film roll 320 can be cut off by the cutter of the film cutting member 314 to form a thin film section 321, and the thin film section 321 is clamped and outputted by the film clamping member 312 so that the clamping jaw 331 can clamp the thin film 321 on the adsorption member 120.

In the embodiments, because the thin film 321 generally has certain ductility, a blade surface of the cutter can be arranged in a sawtooth shape with tooth tips being in an acute angle, thus facilitating cutting off of the thin film 321.

The first film covering driving mechanism 316 can be used for driving the film cutting member 314 to move in a direction close to or away from the thin film 321. The first film covering driving mechanism 316 can be in power coupling connection with the film cutting member 314, and the film cutting member 314 is driven by the first film covering driving mechanism 316 to move in the direction close to the thin film 321 so that the thin film 321 can be cut off; and the film cutting member 314 is driven by the first film covering driving mechanism 316 to move in the direction away from the thin film 321 so that the thin film 321 can be separated from the thin film 321, and one-time cutting action is completed.

In the embodiments, the first film covering driving mechanism 316 can be a driving cylinder or a linear motor, which is not limited here.

In actual implementation, the film clamping member 312 clamps a free end of the thin film 321, and as the free end of the thin film 321 is pulled to move, the thin film roll 320 will rotate on the supporting frame 311 along with the pulling-out of the thin film 321, thus realizing output of the thin film 321; and after the film clamping member 312 pulls out the thin film 321 by the enough length, the film cutting member 314 is driven by the first film covering driving mechanism 316 to move in the direction close to the thin film 321 so that the thin film 321 can be cut into the thin film section 321 and is outputted by the film clamping member 312 for the clamping jaw 331, and thus output of the thin film 321 is completed.

According to the cleaning mechanism 310 provided by the present application, with the cooperation of the thin film roll 320, the film clamping member 312 and the film cutting member 314 on the supporting frame 311, the thin film 321 can be automatically outputted, the output efficiency is high, and the output quality of the thin film 321 is stable. The thin film 321 is outputted for the clamping jaw 331, the waste scraped off by the clamping jaw 331 of the scraping and washing mechanism 330 using the thin film 321 cannot be attached to the clamping jaw 331 of the scraping and washing mechanism 330, thus the influences of waste pollution on the scraping and washing mechanism 330 on subsequent washing can be reduced; and it is not needed to clean the scraping and washing mechanism 330, and therefore the washing efficiency of the adsorption member 120 is improved.

According to some embodiments of the present application, the washing device 300 can further include a second driving mechanism which can be used for driving the cleaning mechanism 310 and the scraping and washing mechanism 330 to move in the direction close to or away from the adsorption member 120.

Because it is needed to lift up the impurity removal member 110 by the adsorption member 120 after iron removal in the impurity removal chamber 110 is finished, before washing, the cleaning mechanism 310 and the scraping and washing mechanism 330 are in a standby state, and it needs to avoid a moving space of the adsorption member 120. When the adsorption member 120 is separated from the impurity removal chamber 110 after iron removal is completed and waits for washing, the second driving mechanism can drive the cleaning mechanism 310 and the scraping and washing mechanism 330 to move in the direction close to the adsorption member 120, thus facilitating the washing of the scraping and washing mechanism 330 to the adsorption member 120.

After all the adsorption members 120 are washed, the second driving mechanism can drive the cleaning mechanism 310 and the scraping and washing mechanism 330 to move in the direction away from the adsorption member 120 and to enter the standby state, thus avoiding interference between the washing device 300 and the adsorption member 120 in movement.

According to the second driving mechanism provided by the present application, the cleaning mechanism 310 and the scraping and washing mechanism 330 are driven to move by means of the second driving mechanism, so that the effect of avoiding the adsorption member 120 can be achieved; and in addition, the cleaning mechanism 310 and the scraping and washing mechanism 330 are driven to be close to the adsorption member 120, so that the adsorption member 120 is conveniently washed by the scraping and washing mechanism 330, the space for tools of the cleaning mechanism 310 and the scraping and washing mechanism 330 can be reduced, and the device size and the production cost are optimized.

As shown in FIG. 6 and FIG. 7, according to some embodiments of the present application, the washing device 300 can further include a first supporting member 301, the cleaning mechanism 310 and the scraping and washing mechanism 330 are both mounted on the first supporting member 301, and the second driving mechanism is used for driving the first supporting member 301 to move in the direction close to and away from the adsorption member 120.

The first supporting member 301 can be movably mounted on the impurity removal system 100; the cleaning mechanism 310 and the scraping and washing mechanism 330 are mounted on the first supporting member 301, so that the first supporting member 301 can drive the cleaning mechanism 310 and the scraping and washing mechanism 330 to move on the impurity removal system 100; and the second driving mechanism is in power coupling connection with the first supporting member 301 so as to drive the first supporting member 301 to move in the direction close to and away from the adsorption member 120.

As shown in FIG. 6 and FIG. 7, in the embodiments, the first supporting member 301 can be a supporting plate extending in the horizontal direction, the cleaning mechanism 310 and the scraping and washing mechanism 330 are both mounted on the supporting plate, a sliding rail and sliding block structure can be arranged between the supporting plate and the impurity removal system 100, and a sliding rail can extend in the direction close to and away from the adsorption member 120 so that the supporting plate can move in the direction close to and away from the adsorption member 120.

It is to be noted that as shown in FIG. 1, the first driving mechanism 130 is in power coupling connection with the first supporting member 301 so as to drive the first supporting member 301 to move in the axial direction of the adsorption member 120.

The second driving mechanism can be a driving cylinder and can also be a linear motor or a ball screw structure, which is not limited here.

According to the first supporting member 301 provided by the present application, the cleaning mechanism 310 and the scraping and washing mechanism 330 are integrated on the first supporting member 301, which facilitates driving, assembling and overhauling of the cleaning mechanism 310 and the scraping and washing mechanism 330.

As shown in FIG. 6 and FIG. 12, according to some embodiments of the present application, the scraping and washing mechanism 330 can further include a second scraping and washing driving mechanism 333 which can be used for driving a clamping jaw 331 to move in the direction close to or away from the adsorption member 120.

The second scraping and washing driving mechanism 333 is in power coupling connection with the clamping jaw 331; the clamping jaw 331 is driven to be close to the adsorption member 120 by the second scraping and washing driving mechanism 333, and in the moving process that the clamping jaw 331 is close to the adsorption member 120, the clamping jaw 331 can pass through the thin film 321 and clamp the thin film 321 on the adsorption member 120; after washing is completed, the second scraping and washing driving mechanism 333 drives the clamping jaw 331 to move in the direction away from the adsorption member 120, the clamping jaw 331 and the adsorption member 120 are spaced by a certain distance, and thus the cleaning mechanism 310 can conveniently convey the output film 321 to be between the clamping jaw 331 and the adsorption member 120.

As shown in FIG. 6 and FIG. 12, in the embodiments, the second scraping and washing driving mechanism 333 can be mounted on the first supporting member 301, the second scraping and washing driving mechanism 333 is in power coupling connection with the first scraping and washing driving mechanism 332 and the clamping jaw 331, a sliding block and sliding rail structure is arranged between the first scraping and washing driving mechanism 332 and the clamping jaw 331 and the first supporting member 301 so that the first scraping and washing driving mechanism 332 and the clamping jaw 331 can slide on the first supporting member 301; and the first scraping and washing driving mechanism 332 and the clamping jaw 331 are driven to move in the direction close to or away from the adsorption member 120 by means of the second scraping and washing driving mechanism 333.

It is to be noted that the second scraping and washing driving mechanism 333 can be a driving cylinder or a linear motor or the like, which is not limited here. As shown in FIG. 6 and FIG. 12, in the embodiments, the second scraping and washing driving mechanism 333 is the driving cylinder.

In actual implementation, when washing the adsorption member 120, the second driving mechanism can firstly drive the first supporting member 301 to be close to the adsorption member 120, thus the cleaning mechanism 310 and the scraping and washing mechanism 330 are close to the adsorption member 120, which reduces the movement stroke of the clamping jaw 331, and reduces the tool size. The cleaning mechanism 310 outputs the thin film 321 to be between the clamping jaw 331 and the adsorption member 120, the second scraping and washing driving mechanism 333 drives the clamping jaw 331 to move close to the adsorption member 120, and in this process, it passes through the thin film 321 and abuts against the adsorption member 120; and the film clamping member 312 releases the thin film 321 to make the thin film 321 separate from the film clamping member 312 while the clamping jaw 331 moves or before the clamping jaw 331 moves. The first scraping and washing driving mechanism 332 drives the clamping jaw 331 to clamp, and the thin film 321 abutting against the adsorption member 120 by the clamping jaw 331 is wrapped on the outer surface of the adsorption member 120 in a surrounding manner.

According to the second scraping and washing driving mechanism 333 provided by the present application, the second scraping and washing driving mechanism 333 drives the clamping jaw 331 to move in the direction close to the adsorption member 120, the clamping jaw 331 can pass through the thin film 321 and clamp the thin film 321 to the adsorption member 120, the waste scraped off by the clamping jaw 331 of the scraping and washing mechanism 330 using the thin film 321 cannot be attached to the clamping jaw 331 of the scraping and washing mechanism 330, thus the influence of waste contamination on the scraping and washing mechanism 330 on subsequent washing can be reduced; and it is not needed to clean the scraping and washing mechanism 330, so that the washing efficiency of washing the adsorption member 120 is improved.

As shown in FIG. 6 and FIG. 7, according to some embodiments of the present application, the cleaning mechanism 310 can further include a second film covering driving mechanism 317 which can be used for driving the film clamping member 312 to move in the direction close to or away from the adsorption member 120.

The second film covering driving mechanism 317 can be in power coupling connection with the film clamping member 312, the second film covering driving mechanism 317 drives the film clamping member 312 to moves in the direction get close to the adsorption member 120, the film clamping member 312 moves in the direction away from the thin film roll 320 so as to pull out the thin film 321 from the thin film roll 320 and drive the thin film 321 to move to be between the clamping jaw 331 and the adsorption member 120.

As shown in FIG. 6 to FIG. 11, in the embodiments, the second film coating driving mechanism 317 can be a linear motion module which is in power coupling connection with the film clamping member 312, and the linear motion module can include a driving motor, a lead screw guide rail and a sliding block, in which, the lead screw guide rail is matched with the sliding block, the film clamping member 312 is fixedly connected to the sliding block; and the driving motor drives the lead screw guide rail to rotate to drive the sliding block to slide, so as to drive the film clamping member 312 to move.

In actual implementation, as shown in FIG. 9, when outputting the thin film 321, the second film coating driving mechanism 317 firstly drives the film clamping member 312 to move by a first distance in the direction close to the adsorption member 120, and the first distance is the length of the thin film 321 pulled out by the film clamping member 312, namely the length of the thin film section 321. As shown in FIG. 10, after the film cutting member 314 cuts off the thin film 321, the second film coating driving mechanism 317 will continue to drive the film clamping member 312 to move in the direction close to the adsorption member 120 till the film clamping member 312 is between the clamping jaw 331 and the adsorption member 120. As shown in FIG. 11, after the clamping jaw 331 stretches out and clamps the thin film 321 on the adsorption member 120, the second film coating driving mechanism 317 will drive the film clamping member 312 to move to the initial position in the direction away from the adsorption member 120, and the film clamping member 312 can clamp the free end of the thin film 321 extending out of the thin film roll 320 to wait for next outputting to the thin film 321.

According to the second film coating driving mechanism 317 provided by the present application, the second film coating driving mechanism 317 drives the film clamping member 312 to drive the thin film 321 to move so as to output the thin film 321 to be between the clamping jaw 331 and the adsorption member 120, the clamping jaw 331 can pass through the thin film 321 and clamps the thin film 321 on the adsorption member 120, thus the waste scraped off by the clamping jaw 331 of the scraping and washing mechanism 330 using the thin film 321 cannot be attached to the clamping jaw 331 of the scraping and washing mechanism 330, and the influence of pollution of the waste on subsequent washing of the scraping and washing mechanism 330 can be reduced; and it is not needed to clean the scraping and washing mechanism 330, so that the washing efficiency of washing the adsorption member 120 is improved.

As shown in FIG. 6 and FIG. 7, according to some embodiments of the present application, the cleaning mechanism 310 can further include a third film covering driving mechanism 318 which can be used for driving a film clamping member 312 to clamp or release the thin film 321.

The third film covering driving mechanism 318 can be in power coupling connection with the film clamping member 312 so as to drive the film clamping member 312 to clamp or release the thin film 321.

As shown in the figures, it is to be noted that the third film covering driving mechanism 318 can be a driving cylinder or a driving motor or the like, which is not limited here. In the embodiments, the third film covering driving mechanism 318 is the driving cylinder.

In actual implementation, when the cleaning mechanism 310 outputs the thin film 321, the third film covering driving mechanism 318 will firstly drive the film clamping member 312 to clamp the free end of the thin film 321 that is pulled out of the thin film roll 320; after the second film covering driving mechanism 317 drives the film clamping member 312 to drive the thin film 321 to move be between the clamping jaw 331 and the adsorption member 120, the third film covering driving mechanism 318 will drive the film clamping member 312 to release the thin film 321, the thin film 321 is separated from the clamping member and clamped on the adsorption member 120 by the clamping jaw 331; and after the second film covering driving mechanism 317 drives the film clamping member 312 to return to the initial position, the film clamping member 312 is just located on the upper side and the lower side of the free end of the thin film 321 that is pulled out of the thin film roll 320, and the third film covering driving mechanism 318 drives the film clamping member 312 to clamp the thin film 321 to wait for next outputting to the thin film 321.

According to the third film covering driving mechanism 318, the film clamping member 312 can be driven to achieve the actions of clamping and releasing the thin film 321 so that the film clamping member 312 can convey the thin film 321 to be between the clamping jaw 331 and the adsorption member 120 and release the thin film 321, the waste scraped off by the clamping jaw 331 of the scraping and washing mechanism 330 using the thin film 321 cannot be attached to the scraping and washing mechanism 330, thus the influence of the waste scraping and washing mechanism 330 on subsequent washing can be reduced; and it is not needed to clean the scraping and washing mechanism 330, and thus the washing efficiency of washing the adsorption member 120 is improved.

As shown in FIG. 8 to FIG. 10, according to some embodiments of the present application, the film clamping member 312 can include a first clamping member 3121 and a second clamping member 3122, in which, the first clamping member 3121 can be provided with a first clamping surface, the second clamping member 3122 can be provided with a second clamping surface, the first clamping surface and the second clamping surface are oppositely arranged and are used for clamping the thin film 321; and the third film covering driving mechanism 318 can be connected to at least one of the first clamping member 3121 and the second clamping member 3122 and is used for driving the first clamping surface and the second clamping surface to be close to or away from each other.

The third film covering driving mechanism 318 can be connected to at least one of the first clamping member 3121 and the second clamping member 3122 so as to drive at least one of the first clamping member 3121 and the second clamping member 3122 to move; when the first clamping member 3121 moves, the first clamping surface can move along with the first clamping member 3121; and when the second clamping member 3122 moves, the second clamping surface can move along with the second clamping member 3122.

In the embodiments, the first clamping surface and the second clamping surface can be oppositely arranged in the axial direction of the adsorption member 120 and are located on the upper side and the lower side of the thin film 321 correspondingly, and the first clamping surface on the upper side is taken as an example for description here.

In one example, the third film covering driving mechanism 318 can be connected to the first clamping member 3121 to drive the first clamping member 3121 to move in the vertical direction, so that the first clamping surface is driven to move in the vertical direction, and the second clamping member 3122 is kept fixed. When the first clamping surface moves downwards and abuts against the second clamping surface, the film clamping member 312 can clamp the thin film 321; and when the first clamping surface moves upwards and is separated from the second clamping surface, the thin film 321 is released.

In another example, the third film covering driving mechanism 318 can be connected to the second clamping member 3122 to drive the second clamping member 3122 to move in the vertical direction, so that the second clamping surface is driven to move in the vertical direction, and the first clamping member 3121 is kept fixed. When the second clamping surface moves upwards and abuts against the first clamping surface, the film clamping member 312 can clamp the thin film 321; and when the second clamping surface moves downwards and is separated from the first clamping surface, the thin film 321 is released.

In yet another example, the third film covering driving mechanism 318 can be connected to the first clamping member 3121 and the second clamping member 3122 respectively, and the movement of the first clamping member 3121 and the second clamping member 3122 can refer to the above examples. When the first clamping surface and the second clamping surface move oppositely and abut against each other, the film clamping member 312 clamps the thin film 321; and when the first clamping surface and the second clamping surface move oppositely and are separated from each other, the thin film 321 is released.

According to the two clamping members in the embodiments of the present application, the first clamping surface and the second clamping surface are arranged to facilitate clamping on the two sides of the thin film 321, and the clamping effect is improved.

As shown in FIG. 10, according to some embodiments of the present application, the first clamping member 3121 can include a first connecting arm 31211 and a first clamping portion 31212. The first connecting arm 31211 can be connected to the output end of the third film covering driving mechanism 318 and is arranged at an interval with the second clamping member 3122 in the clamping direction; and the first clamping portion 31212 is connected to the first connecting arm 31211 and extends in the direction close to the second clamping member 3122, and the first clamping portion 31212 is provided with the first clamping surface.

One end of the first connecting arm 31211 can be connected to the output end of the third film covering driving mechanism 318, the first connecting arm 31211 is driven by the third film covering driving mechanism 318 to move so as to achieve clamping and releasing, the second clamping member 3122 can be kept fixed or one end of the second clamping member 3122 is also connected to the output end of the third film covering driving mechanism 318, which can refer to the previous embodiments.

The other end of the first connecting arm 31211 can extend in the direction close to the adsorption member 120, the other end of the second clamping member 3122 can also extend in the direction close to the adsorption member 120, and the first connecting arm 31211 and the second clamping member 3122 are arranged at an interval in the clamping direction so as to be assembled on the third film covering driving mechanism 318. The second clamping surface is arranged on the other surface of the second clamping member 3122, the first clamping portion 31212 is connected to the other end of the first connecting arm 31211 and extends in the direction close to the second clamping member 3122 so as to facilitate the first clamping surface to be close to the second clamping surface, and thus reducing the moving stroke of the first connecting arm 31211 or the second clamping member 3122.

According to the embodiments, the first connecting arm 31211 is arranged, so that when the first clamping surface and the second clamping surface clamp and output the thin film 321, the first connecting arm 31211 and the second clamping member 3122 can extend out of the first supporting member 301 and are close to the adsorption member 120 as much as possible, and the thin film 321 can be conveniently outputted to be between the clamping jaw 331 and the adsorption member 120.

As shown in FIG. 10, according to some embodiments of the present application, the first clamping portion 31212 can include a first section 31212a and a second section 31212b which are connected in a bent mode, the second section 31212b can be connected to the first connecting arm 31211 through the first section 31212a, and the first section 31212a can extend in the clamping direction of the first connecting arm 31211 and the second clamping member 3122 and is suitable for being located on the outer side of the thin film 321.

In the embodiment, the first connecting arm 31211 can be arranged on the lower side of the second clamping member 3122, the first section 31212a extends in the clamping direction of the first connecting arm 31211 and the second clamping member 3122, in which, the lower end of the first section 31212a is connected to the first connecting arm 31211 while the other end thereof extends upwards; and one end of the second section 31212b is connected to the upper end of the first section 31212a and is located on the upper side of the second clamping member 3122.

The first clamping surface is arranged on the lower end face of the second section 31212b, the second clamping surface is arranged on the upper side surface of the second clamping member 3122, and therefore when the first clamping surface and the second clamping surface clamp the thin film 321, the first section 31212a can be located on the outer side of the thin film 321, which achieves the effect of positioning the edge of the thin film 321, and reduces the deviation probability of the thin film 321. As shown in FIG. 6, FIG. 7, FIG. 9 and FIG. 10, according to some embodiments of the present application, two film clamping members 312 can be oppositely arranged and can be used for clamping the two sides of the thin film 321 correspondingly, and the clamping jaw 331 can be located between the two film clamping members 312.

As shown in FIG. 9, two film clamping members 312 are provided and are oppositely arranged on the two sides of the thin film 321 in a width direction and are used for clamping the two sides of the thin film 321 in the width direction correspondingly, and the two film clamping members 312 can act synchronously, and therefore when the two film clamping members 312 clamp the thin film 321 and drag the thin film 321 to move, the thin film 321 on the thin film roll 320 can be evenly unfolded, and the cut thin film section 321 can move smoothly.

As shown in FIG. 10, the clamping jaw 331 can be located between the two film clamping members 312 and can be located on the lower sides of the two film clamping members 312; when the two film clamping members 312 drag the thin film section 321 to move to be between the clamping jaw 331 and the adsorption member 120, the non-clamped end of the thin film section 321 droops downwards to the side of the clamping jaw 331 facing the adsorption member 120 due to the gravity, and the thin film section 321 is right located between the clamping jaw 331 and the adsorption member 120; and when the clamping jaw 331 moves close to the adsorption member 120, the center of the clamping jaw 331 can be aligned with the middle of the thin film section 321, the clamping jaw 331 is folded to be clamped on the adsorption member 120 so that the thin film 321 can be driven to wrap the outer side wall of the adsorption member 120 in a surrounding manner, and the situation that the thin film 321 cannot completely wrap the adsorption member 120 is avoided.

In actual implementation, the two film clamping members 312 are clamped on the two sides of the thin film section 321 in the width direction correspondingly, and the thin film section 321 is dragged to be between the clamping jaw 331 and the adsorption member 120 in a horizontal direction; and when the non-clamped end of the thin film section 321 exceeds the clamping jaw 331, it will droops downwards due to gravity, and the thin film section 321 is unfolded between the clamping jaw 331 and the adsorption member 120 in the vertical direction.

According to the two film clamping members 312 provided by the present application, the thin film 321 can be dragged until the center of the clamping jaw 331 is right aligned with the middle of the thin film 321, thus preventing the thin film 321 from failing to completely wrap the adsorption member 120 to affect the washing effect.

As shown in FIG. 10, in some embodiments, when there are two film clamping members 312, the second sections 31212b of two first clamping portions 31212 will extend oppositely. In addition, in the embodiments, the second clamping member 3122 further includes a second connecting arm and second clamping portions, in which, the second clamping portion is connected to the second connecting arms, the second connecting arm and the first connecting arm 31211 are oppositely arranged in the clamping direction at an interval; two second clamping portions and the two first clamping portions 31212 are opposite to each other and are arranged in an opposite extending way; and the second clamping surfaces are arranged on the second clamping portions.

The two first clamping portions 31212 extend oppositely, the same as the two second clamping portions, and therefore the two ends of the thin film 321 can be clamped conveniently, the clamping distance in the width direction of the thin film 321 can be guaranteed, and the thin film 321 can be unfolded better. As shown in FIG. 8 and FIG. 9, according to some embodiments of the present application, the cleaning mechanism 310 can further include at least one roller shaft 322, a compressing plate 313 and a film pressing member 315.

The roller shaft 322 can be used for supporting the thin film 321 between the supporting frame 311 and the film clamping member 312. The film clamping member 312 is located on the lower side of the thin film roll 320 and moves in the horizontal direction, the roller shaft 322 is rotationally mounted on the first supporting member 301, the axis of the roller shaft 322 is parallel to the axis of the thin film roll 320, and the thin film 321 pulled out from the thin film roll 320 passes through the roller shaft 322 and then is clamped on the film clamping member 312. The roller shaft 322 is arranged to achieve the effects of tensioning, unfolding and guiding the thin film 321.

It is to be noted that one or two or more roller shafts 322 can be arranged, and the number is not limited here and is determined according to the actual situation. As shown in FIG. 6, in the embodiments, the two roller shafts 322 are arranged and are parallel to each other.

The compressing plate 313 and the film pressing member 315 are oppositely arranged, and the film pressing member 315 is used for compressing the thin film 321 towards the compressing plate 313. The compressing plate 313 is arranged on the first supporting member 301 and is opposite to the film pressing member 315, the film pressing member 315 is located between the roller shaft 322 and the film cutting member 314, and the film cutting member 314 is located between the film pressing member 315 and the film clamping member 312; and when the free end of the thin film 321 is pulled out by a first distance by the film pressing member 315, the free end is compressed on the upper side of the thin film 321 by the film pressing member 315, and the thin film 321 is compressed on the compressing plate 313, then the film cutting member 314 is driven to cut off the thin film 321, and therefore, the film cutting effect is guaranteed.

The cutter of the film cutting member 314 corresponds to the side of the compressing plate 313 facing film clamping members 312, so that the cutter can slide along the side edge of the compressing plate 313 during cutting, and the thin film 321 is prevented from extending. The film pressing member 315 is matched with the film clamping members 312 to compress the two ends of the thin film 321 in the length direction, so that the film cutting member 314 cuts off the thin film 321 more easily. As shown in FIG. 8 and FIG. 9, in the embodiments, the cleaning mechanism 310 further includes a fourth film covering driving mechanism 319 which is in power coupling connection with the film pressing member 315 and is used for driving the film pressing member 315 to move in the direction close to and away from the thin film roll 320. The fourth film covering driving mechanism 319 can be a driving cylinder or a linear motor, which is not limited here.

As shown in FIG. 8, in some embodiments, two gaps 3131 can be formed in the side of the compressing plate 313 facing the film clamping member 312, and the two gaps 3131 are formed in the two ends of the thin film 321 in the width direction respectively. After the film cutting member 314 cuts the thin film 321, the free end of the thin film 321 is flush with the end of the compressing plate 313 facing the film clamping members 312; and by the gaps 3131, when the second film covering driving mechanism 317 drives the film clamping members 312 to return to the initial position, second sections and second clamping portions of the two film clamping members 312 exactly correspond to the two gaps 3131 in position, so that the first clamping surfaces and the second clamping surfaces can exactly correspond to the upper side surfaces and the lower side surfaces of the thin film 312 located at the gaps 3131, and the thin film 312 is clamped conveniently.

As shown in FIG. 11 and FIG. 12, according to some embodiments of the present application, the clamping jaw 331 can include a first jaw body 3311 and a first hinge arm 3312 which are hinged, a second jaw body 3313 and a second hinge arm which are hinged; the first jaw body 3311 and the second jaw body 3313 are mounted on a support of the scraping and washing mechanism 330 in a pivoted mode, the first hinge arm 3312 and the second hinge arm can be in sliding fit with the support of the scraping and washing mechanism 330, and the first scraping and washing driving mechanism 332 can be used for driving the first hinge arm 3312 and the second hinge arm to slide relative to the support of the scraping and washing mechanism 330.

In the embodiments, one end of the first jaw body 3311 can be hinged to one end of the first hinge arm 3312, one end of the second jaw body 3313 can be hinged to one end of the second hinge arm, the middle of the first jaw body 3311 and the middle of the second jaw body 3313 are mounted on the support of the scraping and washing mechanism 330 in a pivoted mode, the first jaw body 3311 is driven by the first hinge arm 3312 to move, the second jaw body 3313 is driven by the second hinge arm to move, the other end of the first jaw body 3311 and the other end of the second jaw body 3313 can be oppositely folded and separated, and thus clamping and opening of the clamping jaw 331 are achieved.

The other end of the first hinge arm 3312 and the other end of the second hinge arm can be in sliding fit with the support of the scraping and washing mechanism 330, the first scraping and washing driving mechanism 332 is connected to the other end of the first hinge arm 3312 and the other end of the second hinge arm and can drive the first hinge arm 3312 and the second hinge arm to move, and then the first jaw body 3311 and the second jaw body 3313 are driven to move.

In the embodiments, the first jaw body 3311 and the second jaw body 3313 are clamped on the adsorption member 120 and driven by the first hinge arm 3312 and the second hinge arm to rotate to achieve clamping and opening actions.

As shown in FIG. 6 and FIG. 7, according to some embodiments, the cleaning mechanism 310 can further include a first sensor 341 which is mounted on the supporting frame 311, faces the thin film roll 320, and is used for detecting the roll diameter of the thin film roll 320.

The first sensor 341 is used for detecting the roll diameter of the thin film roll 320. The first sensor 341 is fixedly mounted on the supporting frame 311 and used for detecting the diameter of the thin film roll 320; with the pulling-out of the thin film 321 on the thin film roll 320, the diameter of the thin film roll 320 decreases; the roll diameter of the thin film roll 320 is detected by the first sensor 341; and when the roll diameter of the thin film roll 320 is lower than a set threshold, an alarm signal for replacing the thin film roll 320 will be sent out.

As shown in FIG. 6 and FIG. 7, in the embodiments, the first sensor 341 can be an infrared sensor or a photoelectric sensor, an induction probe of the first sensor 341 is vertical to the axis of the thin film roll 320 and is arranged in a staggered manner, and the interval distance from the induction probe of the first sensor 341 to the axis of the thin film roll 320 can be equal to the inner diameter radius of the thin film roll 320 or slightly larger than the inner diameter radius of the thin film roll 320 so as to achieve early warning. When the first sensor 341 cannot detect an induction signal to the thin film 321, an alarm signal will be sent out.

As shown in FIG. 6, according to some embodiments of the present application, the cleaning mechanism 310 can further include a second sensor 342 which is mounted on the supporting frame 311 and faces a position between the thin film roll 320 and the film clamping member 312, and the second sensor 342 is used for detecting whether there is the thin film 321 between the thin film roll 320 and the film clamping member 312. The second sensor 342 is used for detecting whether there is the thin film 321 between the thin film roll 320 and the film clamping member 312. The second sensor 342 is arranged between the thin film roll 320 and the film clamping member 312, whether there is the thin film 321 between the thin film roll 320 and the film clamping member 312 is detected by the second sensor 342, thus whether the thin film 321 on the thin film roll 320 is normally pulled out or not can be determined, and assistance is provided for determining whether there is the thin film 321 on the thin film roll 320 or not. If the second sensor 342 does not detect the thin film 321, an abnormal alarm signal will be sent out so that checking can be carried out in time.

As shown in FIG. 6, in the embodiments, the second sensor 342 can be located between the thin film roll 320 and the roller shaft 322, and the second sensor 342 can be the photoelectric sensor.

As shown in FIG. 6 and FIG. 7, according to some embodiments of the present application, the cleaning mechanism 310 can further include a third sensor 343 which is mounted on the supporting frame 311 and faces the thin film roll 320, and the third sensor 343 is used for detecting the rotating state of the thin film roll 320.

The third sensor 343 is used for detecting the rotating state of the thin film roll 320. The third sensor 343 is fixedly mounted on the supporting frame 311, and is used for detecting the rotating state of a rotating shaft on the supporting frame 311 so as to detect the rotating state of the thin film roll 320; and when the thin film roll 320 cannot rotate due to faults of the rotating shaft, the faults can be timely discovered, thus the plastic deformation probability generated when the film clamping member 312 pulls the thin film 321 is reduced, and the normal output of the thin film 321 is guaranteed.

As shown in FIG. 6 and FIG. 7, in the embodiments, the third sensor 343 can be a U-shaped photoelectric sensor; and the rotating shaft is connected to an induction tooth plate, and a tooth part of the induction tooth plate can pass through an induction area of the U-shaped photoelectric sensor to detect the rotating state of the thin film roll 320.

According to the three sensors provided by the present application, the first sensor 341, the second sensor 342 and the third sensor 343 are used for determining the working state of the cleaning mechanism 310 to improve the stability of the cleaning mechanism 310 outputting the thin film 321 so as to improve the washing effect and the washing efficiency.

As shown in FIG. 6, in some embodiments, a damper 323 is arranged on the supporting frame 311, and is connected to the rotating shaft to improve the stability of the rotating shaft so as to reduce incapability of tensioning the thin film 321 due to free rotation factors of the rotating shaft.

As shown in FIG. 1, according to some embodiments, the washing device 300 can further include a waste collecting mechanism 350 and a third driving mechanism.

The waste collecting mechanism 350 can be used for bearing the waste and the spacer. The third driving mechanism can be used for driving the waste collecting mechanism 350 to move between a storage position and the position below the absorbing member 120.

The waste collecting mechanism 350 can be movably arranged on the impurity removal system 100, and is located on the lower side of the first supporting member 301; and the third driving mechanism is in power coupling connection with the waste collecting mechanism 350 for driving the waste collecting mechanism 350 to move between the storage position and the position below the absorbing member 120.

When the adsorption member 120 works in the impurity removal chamber 110, the waste collecting mechanism 350 is located at the storage position, and at the moment, the waste collecting mechanism 350 is located under the first supporting member 301 so as to avoid the movement of the adsorption member 120. When it is needed to wash the adsorption member 120, the adsorption member 120 moves upwards till being separated from the impurity removal chamber 110, and at the moment, the lower end of the adsorption member 120 is higher than the waste collecting mechanism 350; and the third driving mechanism can drive the waste collecting mechanism 350 to move to the position below the adsorption member 120 so as to receive the waste and the thin film 321 cleaned away by the scraping and washing mechanism 330, and the waste and the thin film 321 obtained by washing are prevented from falling into the impurity removal chamber 110.

In the embodiments, the third driving mechanism can be a driving cylinder and can also be a linear movement module, which is not limited here. The waste collecting mechanism 350 can be arranged in a collecting disc manner.

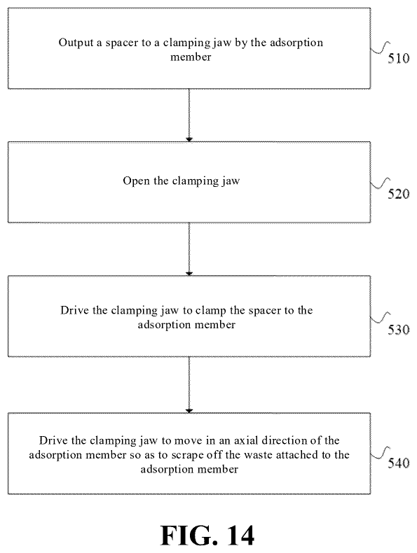

As shown in FIG. 14, in another aspect, the present application further provides a washing method using a washing device 300, and the washing device 300 can be the washing device 300 in any one of the above embodiments. In this embodiment, the washing method includes:
step 510, outputting a spacer to the clamping jaw 331;
step 520, opening the clamping jaw 331;
step 530, driving the clamping jaw 331 to clamp the spacer to the adsorption member 120; and
step 540, driving the clamping jaw 331 to move in the axial direction of the adsorption member 120 so as to scrape off the waste attached to the adsorption member 120.

It is to be noted that the washing device 300 in this embodiment includes the washing device 300 in any one of the above embodiment, so corresponding technical characteristics in the washing device 300 are included, corresponding technical effects are achieved, which will not listed here.

It is to be noted that there is no absolute front-back sequence relationship between the steps of the cleaning method, for example, step 510 can be before step 520, or step 510 can be after step 520, or step 510 and step 520 are implemented synchronously.

According to the washing method provided by this embodiment of the present application, the spacer is outputted by the cleaning mechanism, so that the waste scraped by the clamping jaw 331 of the scraping and washing mechanism 330 using the spacer cannot be attached to the clamping jaw 331 of the scraping and washing mechanism 330, the influence of the waste polluting the scraping and washing mechanism 330 on subsequent washing can be reduced, the cleaning to the scraping and washing mechanism 330 is reduced, and accordingly the washing efficiency of washing the adsorption member 120 is improved.

According to some embodiments of the present application, the spacer is the thin film 321; and
step 510 further includes:
step 511, clamping one end of the thin film 321 by the film clamping member 312 of the washing device 300; and
step 512, cutting off the other end of the thin film 321 by the film cutting member 314 of the washing device 300.

According to the washing method provided by this embodiment of the present application, one end of the thin film 321 is clamped by the clamping member, and the other end of the thin film 321 is cut off by the film cutting member 314, so that the output of the thin film 321 is realized; and the film clamping member 312 clamps one end of the thin film 321 to convey the thin film 321 to the clamping jaw 331 for use.

According to some embodiments of the present application, step 540 includes:
step 541, driving the clamping jaw 331 to move to the exterior of the adsorption member 120 in the axial direction of the adsorption member 120.

In this embodiment, the clamping jaw 331 drives the spacer to move to the exterior of the adsorption member 120, so that the whole adsorption member 120 is washed, the separation of the spacer and the adsorption member 120 is realized, and impurities obtained after washing are prevented from being attached to the adsorption member 120 again.

According to some embodiments of the present application, with reference to FIG. 1 to FIG. 12, the present application provides an impurity removal system 100 which includes the impurity removal chamber 110, the impurity removal device 200 and the washing device 300.

As shown in FIG. 1, a plurality of impurity removal chambers 110 can be arranged; in the embodiments, four impurity removal chambers 110 are arranged and are connected end to end; and the impurity removal chamber at the head end is connected to a feeding pipe, and the impurity removal chamber at the tail end is connected to a discharging pipe. The impurity removal channels extending in the vertical direction are arranged in the impurity removal chambers 110, and each impurity removal chamber 110 can include a plurality of impurity removal channels which are distributed at intervals in the circumferential direction of the impurity removal chamber 110.

Four impurity removal devices 200 are arranged corresponding to the impurity removal chambers 110, and four cleaning devices 300 are arranged corresponding to the impurity removal devices 200. The impurity removal devices 200 are further in power coupling connection with the lifting device of the impurity removal system 100, and the lifting device can drive the impurity removal devices 200 to move in the vertical direction.

As shown in FIG. 2 to FIG. 5, each impurity removal device 200 includes the supporting structure 210, the adsorption assembly 220, the adsorption driving mechanism 223, the positioning mechanism 201, the cover body 230 and the driving mechanism 237 for cover body 230.

Each supporting structure 210 includes a supporting member 211 and a fixing member, in which, the lifting device is in power coupling connection with the supporting member 211, the fixing member is arranged on the lower side of the supporting member 211 and fixedly connected to the supporting member 211 by a connecting structure 216, the connecting structure 216 includes a spring seat 217 and a bolt 218, the spring seat 217 is arranged on the upper surface of the fixing member, the upper end of the spring seat 217 abuts against the lower surface of the supporting member 211, and the bolt 218 penetrates through a mounting hole in the supporting member 211 from top to bottom so as to be in threaded connection with the spring seat 217. A plurality of connecting structures 216 can be provided; and in the embodiments, four connecting structures 216 are provided and are distributed in the circumferential direction of the fixing member at intervals

Each adsorption assembly 220 includes a mounting member 221 and a plurality of adsorption members 120, in which, the plurality of adsorption members 120 are mounted on the mounting member 221 around the rotating axis of the mounting member 221 at intervals, and the plurality of adsorption members 120 correspond to the plurality of impurity removal channels of the corresponding impurity removal chamber 110 in a one-to-one manner. Each mounting member 221 is arranged on the lower side of the corresponding fixing member and can rotate relative to the corresponding fixing member, and a plane needle bearing is arranged between each mounting member 221 and the corresponding fixing member.

A mounting bracket 219 is arranged on the upper surface of each supporting member 211, each mounting bracket 219 and the corresponding supporting member 211 are arranged at an interval, and each adsorption driving mechanism 223 is fixedly mounted on the corresponding mounting bracket 219. Each adsorption driving mechanism 223 includes a driving motor, a speed reducer and a transmission shaft 224, in which, the speed reducer is connected to the output end of the driving motor, the upper end of the transmission shaft 224 is in power coupling connection with the speed reducer, the transmission shaft 224 sequentially penetrates through the corresponding supporting member 211 and the corresponding fixing member from top to bottom so as to be connected to the corresponding mounting member 221, a rolling bearing is arranged between each transmission shaft 224 and the corresponding fixing member, and the mounting member 221 is driven by the transmission shaft 224 to rotate around the axis of the transmission shaft 224.

The positioning mechanism 201 is mounted on the upper surface of the supporting member 211 and includes a positioning cylinder and a positioning rod 202, in which, the positioning rod 202 extends in the vertical direction, and the positioning cylinder is used for driving the positioning rod 202 to be arranged in a telescopic mode in the vertical direction. The fixing member is provided with a fixing member avoiding hole 215; a mounting member 221 is provided with a positioning groove 222; and when the mounting member 221 rotates to the target position, the positioning rod 202 can penetrate through the fixing member avoiding hole 215 and is matched with the positioning groove 222 for positioning.

The cover body 230 includes a cover plate 231 and locking members 235. The cover plate 231 is arranged between the fixing member and the supporting member 211, a supporting portion 213 is arranged at the lower end of the supporting member 211, and a rolling bearing is arranged between the supporting portion 213 and the cover plate 231 so that the cover plate 231 can rotate relative to the fixing member and the supporting member 211. Moreover, the cover plate 231 is provided with a first avoiding hole 232, and the first avoiding hole 232 is in an arc shape with circle center on the rotating axis of the cover body 230 so as to avoid the positioning rod 202. The cover plate 231 is provided with the second avoiding holes 233 for cover body, the second avoiding holes 233 for cover body are in an arc shape with circle center on the rotating axis of the cover body 230, the second avoiding holes 233 for the cover body are used for allowing spring seats 217 to penetrate through, and four second avoiding holes 233 for the cover body are formed corresponding to the spring seats 217.

The cover plate 231 can be arranged at an opening of the impurity removal chamber 110 in a covering mode, a plurality of extending portions extending outwards are arranged on the periphery of the impurity removal chamber 110 and arranged around the axis of the impurity removal chamber 110 at intervals, the locking members 235 are connected to the cover plate 231 and arranged on the lower side of the cover plate 231, a plurality of locking members 235 are arranged corresponding to the plurality of extending portions, and blocking portions 236 are arranged at the lower ends of the locking members 235; under the condition that the cover plate 231 rotates to the locking members 235 to be aligned with the extending portions, the upper surfaces of the blocking portions 236 are blocked to the lower surfaces of the extending portions, and thus the impurity removal chamber 110 is sealed through the cover body 230; and under the condition that the cover plate 231 rotates to the locking members 235 to be staggered with the extending portions, the blocking portions 236 are separated from the extending portions, and thus the cover body 230 and the impurity removal chamber 110 are unlocked.

The cover body driving mechanisms 237 are arranged on the upper surface of the supporting member 211, and each cover body driving mechanism 237 includes a telescopic cylinder 238 and a connecting rod 239; one end of each telescopic cylinder 238 is rotationally mounted on the supporting member 211, and the other end of each telescopic cylinder 238 is rotationally connected to the upper end of the corresponding connecting rod 239 around the axis of the connecting rod 239; and the lower end of each connecting rod 239 penetrates through the avoiding port 212 of the supporting member 211 and is rotationally matched with connecting groove 234 of the cover plate 231. The avoiding ports 212 are arranged in an arc shape with circle center on the rotating axis of the cover plate 231, so that when the telescopic cylinders 238 do telescopic motion, the connecting rods 239 can be driven to slide in the avoiding ports 212 along the arc line, and then the cover plate 231 is driven to rotate. Buffer devices 203 are arranged at the ends of the avoiding ports 212 opposite to the telescopic cylinders 238, and each buffer device 203 includes a buffer head 204 and a damper 205; and when the connecting rods 239 move to the ends of the avoiding ports 212 opposite to the telescopic cylinders 238, the connecting rods 239 abut against the buffer heads 204.

A plurality of cover body driving mechanisms 237 can be arranged; in the embodiments, two cover body driving mechanisms 237 are provided and are symmetrically arranged along the rotating axis of the cover plate 231; and two connecting grooves 234, two avoiding ports 212 and two buffer devices 203 are arranged corresponding to the two cover body driving mechanisms 237.

As shown in FIG. 6 to FIG. 12, the washing device 300 includes the cleaning mechanism 310, the scraping and washing mechanism 330, the waste collecting mechanism 350, the first driving mechanism 130, the second driving mechanism and the third driving mechanism.

The cleaning mechanism 310 and the scraping and washing mechanism 330 are mounted on the first supporting member 301, the first supporting member 301 is movably mounted on the impurity removal system 100 in the direction close to and away from the adsorption member 120, and the second driving mechanism drives the first supporting member 301 to drive the cleaning mechanism 310 and the scraping and washing mechanism 330 to move in the direction close to and away from the adsorption member 120.

The cleaning mechanism 310 includes the supporting frame 311, the film clamping member 312, the film cutting member 314, the film pressing member 315, the first film covering driving mechanism 316, the second film covering driving mechanism 317, the third film covering driving mechanism 318 and the fourth film covering driving mechanism 319; the supporting frame 311 is fixedly mounted on the first supporting member 301; the rotating shaft is arranged on the supporting frame 311; the thin film roll 320 is mounted on the rotating shaft; the thin film 321 on the thin film roll 320 is pulled out and the free end of the thin film 321 is clamped by the film clamping member 312; the film clamping member 312 is located on the lower side of the thin film roll 320; the roller shaft 322 is arranged between the thin film roll 320 and the film clamping member 312; the thin film 321 is guided by the roller shaft 322; the third film covering driving mechanism 318 is in power coupling connection with two clamping portions 313 of the film clamping member 312 so as to drive the two clamping portions 313 to clamp the thin film 321; the second film covering driving mechanism 317 is in power coupling connection with the film clamping member 312 so as to drive the film clamping member 312 to drive the thin film 321 to move in the direction close to and away from the adsorption member 120; the film pressing member 315 is arranged between the film clamping member 312 and the supporting frame 311; the fourth film covering driving mechanism 319 is in power coupling connection with the film pressing member 315 so as to drive the film pressing member 315 to move in the direction close to and away from the thin film roll 320, and the film pressing member 315 can press or release the thin film 321; the film cutting member 314 is arranged between the film clamping member 312 and the film pressing member 315; the first film covering driving mechanism 316 is in power coupling connection with the film cutting member 314; and after the film pressing member 315 compresses the thin film 321, the first film covering driving mechanism 316 drives the film cutting member 314 to cut off the thin film 321 to form the thin film section 321, and the second film covering driving mechanism 317 drives the film clamping member 312 to convey the thin film section 321 to be between the scraping and washing mechanism 330 and the adsorption member 120.

The scraping and washing mechanism 330 includes the clamping jaw 331, the first scraping and washing driving mechanism 332 and the second scraping and washing driving mechanism 333; the second scraping and washing mechanism 330 is arranged on the first supporting member 301 and is in power coupling connection with the clamping jaw 331 and the first scraping and washing driving mechanism 332 so as to drive the first scraping and washing mechanism 330 and the clamping jaw 331 to move in the direction close to and away from the adsorption member 120; the second scraping and washing mechanism 330 is in power coupling connection with the clamping jaw 331 so as to drive the clamping jaw 331 to open or clamp; when the clamping jaw 331 clamps, it will clamp the adsorption member 120, the thin film section 321 can be wrapped on the outer surface of the adsorption member 120 in a surrounding manner; and the first driving mechanism 130 is in power coupling connection with the first supporting member 301 so as to drive the first supporting member 301 to move in the axial direction of the adsorption member 120, and then the clamping jaw 331 of the scraping and washing mechanism 330 is driven to move from one end of the adsorption member 120 to the other end of the adsorption member 120 in the axial direction of the adsorption member 120.

The third driving mechanism is in power coupling connection with the waste collecting mechanism 350 and is used for driving the waste collecting mechanism 350 to move between the storage position and the position below the adsorption member 120; and he waste collecting mechanism 350 is located on the lower side of the first supporting member 301 when located at the storage position and is used for collecting waste and the thin film 321 scraped off by the scraping and washing mechanism 330 when located below the adsorption member 120.

It is to be noted that, without conflict, the embodiments in the present application and the features in the embodiments may be combined with each other.

The above are only some examples of the present application, and are not intended to limit the present application. For those skilled in the art, the present application may have various modifications and changes. Any modification, equivalent replacement, improvement, etc. made within the spirit and principle of the present application shall fall within the scope of protection of the present application.

What is claimed is:

1. A washing device, used for washing waste attached to an adsorption member, comprising:
a cleaning mechanism used for outputting a spacer;
a scraping and washing mechanism comprising a clamping jaw and a first scraping and washing driving mechanism, wherein the clamping jaw is used for clamping the adsorption member by means of the spacer, and the first scraping and washing driving mechanism is used for driving the clamping jaw to open or clamp; and
a first driving mechanism used for driving the scraping and washing mechanism to move in an axial direction of the adsorption member, so as to scrape off the waste attached to the adsorption member.

2. The washing device according to claim 1, wherein the spacer is a thin film, and the cleaning mechanism comprises:
a supporting frame used for supporting a thin film roll;
a film clamping member used for clamping the thin film;
a film cutting member used for cutting off the thin film; and
a first film covering driving mechanism used for driving the thin film cutting member to move in a direction close to or away from the thin film.

3. The washing device according to claim 2, wherein the cleaning mechanism further comprises:
a second film covering driving mechanism used for driving the film clamping member to move in a direction close to or away from the adsorption member.

4. The washing device according to claim 2, wherein the cleaning mechanism further comprises:
a third film covering driving mechanism used for driving the film clamping member to clamp or release the thin film.

5. The washing device according to claim 4, wherein:
the film clamping member comprises: a first clamping member and a second clamping member, wherein the first clamping member is provided with a first clamping surface, the second clamping member is provided with a second clamping surface, and the first clamping surface and the second clamping surface are oppositely arranged and are used for clamping the thin film; and
the third film covering driving mechanism is connected to at least one of the first clamping member and the second clamping member and is used for driving the first clamping surface and the second clamping surface to be close to or away from each other.

6. The washing device according to claim 5, wherein the first clamping member comprises:
a first connecting arm which is connected to an output end of the third film covering driving mechanism, wherein the first connecting arm and the second clamping member are arranged at an interval in a clamping direction; and
a first clamping portion which is connected to the first connecting arm, extends in a direction close to the second clamping member, and is provided with the first clamping surface.

7. The washing device according to claim 6, wherein:
the first clamping portion comprises a first section and a second section which are connected in a bent mode; and
the second section is connected to the first connecting arm by the first section, and the first section extends in the clamping direction of the first connecting arm and the second clamping member.

8. The washing device according to claim 2, wherein two film clamping members are oppositely arranged and used for clamping the two sides of the thin film respectively, and the clamping jaw is located between the two film clamping members.

9. The washing device according to claim 2, wherein the cleaning mechanism further comprises:
at least one roller shaft used for supporting the thin film between the supporting frame and the film clamping member; and
a compressing plate and a film pressing member which are oppositely arranged, wherein the film pressing member is used for compressing the thin film towards the compressing plate.

10. The washing device according to claim 2, wherein the cleaning mechanism further comprises:
a first sensor which is mounted on the supporting frame and faces the thin film roll, and the first sensor is used for detecting the roll diameter of the thin film roll.

11. The washing device according to claim 2, wherein the cleaning mechanism further comprises:
a second sensor which is mounted on the supporting frame, faces a position between the thin film roll and the film clamping member, and is used for detecting whether the thin film exists between the thin film roll and the film clamping member.

12. The washing device according to claim 2, wherein the cleaning mechanism further comprises:
a third sensor which is mounted on the supporting frame, faces the thin film roll, and is used for detecting the rotation state of the thin film roll.

13. The washing device according to claim 1, further comprising:
a second driving mechanism which is used for driving the cleaning mechanism to move in a direction close to or away from the adsorption member.

14. The washing device according to claim 13, further comprising:
a first supporting member, wherein the cleaning mechanism and the scraping and washing mechanism are both mounted on the first supporting member, and the second driving mechanism is used for driving the first supporting member to move in a direction close to or away from the adsorption member.

15. The washing device according to claim 1, wherein the scraping and washing mechanism further comprises:
a second scraping and washing driving mechanism which is used for driving the clamping jaw to move in a direction close to or away from the adsorption member.

16. The washing device according to claim 1, wherein:
the clamping jaw comprises: a first jaw body and a first hinge arm which are hinged, a second jaw body and a second hinge arm which are hinged; and
the first jaw body and the second jaw body are mounted on a support of the scraping and washing mechanism in a pivoted manner, the first hinge arm and the second hinge arm are in sliding fit with the support of the scraping and washing mechanism, and the first scraping and washing driving mechanism is used for driving the first hinge arm and the second hinge arm to slide relative to the support of the scraping and washing mechanism.

17. The washing device according to claim 1, further comprising:
a waste collecting mechanism used for bearing the waste and the spacer; and
a third driving mechanism used for driving the waste collecting mechanism to move between a storage position and a position below the adsorption member.

18. An impurity removal system, comprising:
an impurity removal chamber used for accommodating to-be-treated slurry;
an adsorption member which is arranged corresponding to the impurity removal chamber and used for adsorbing waste in the to-be-treated slurry; and
the washing device according to claim 1 and used for washing the waste attached to the adsorption member.

19. The impurity removal system according to claim 18, further comprising:
a lifting device which is connected to the adsorption member and used for driving the adsorption member to be separated from the impurity removal chamber.

20. A washing method using the washing device according to claim 1, comprising:
outputting the spacer to the clamping jaw;
opening the clamping jaw;
driving the clamping jaw to clamp the spacer to the adsorption member; and
driving the clamping jaw to move in an axial direction of the adsorption member so as to scrape off the waste attached to the adsorption member.
